(19) United States
(12) Patent Application Publication
(10) Pub. No.: US 2015/0125790 A1
(43) Pub. Date: May 7, 2015

(54) MAGNETIC TONER

(71) Applicant: CANON KABUSHIKI KAISHA, Tokyo (JP)

(72) Inventors: Yojiro Hotta, Mishima-shi (JP); Koji Nishikawa, Susono-shi (JP); Shohei Tsuda, Suntou-gun (JP); Motohide Shiozawa, Mishima-shi (JP); Takeshi Naka, Suntou-gun (JP); Kazuo Terauchi, Numazu-shi (JP); Katsuhisa Yamazaki, Numazu-shi (JP); Takayuki Itakura, Mishima-shi (JP)

(21) Appl. No.: 14/596,065

(22) Filed: Jan. 13, 2015

Related U.S. Application Data
(63) Continuation of application No. PCT/JP2014/003951, filed on Jul. 28, 2014.

(30) Foreign Application Priority Data
Jul. 31, 2013 (JP) 2013-158913

(51) Int. Cl. G03G 9/08; G03G 9/083

(52) U.S. Cl. CPC G03G 9/0825; G03G 9/083; G03G 9/0819
USPC 430/108.3

(57) ABSTRACT

A magnetic toner having a toner particle containing a binder resin and a magnetic member, a first inorganic fine particle and an organic-inorganic composite particle on the surface of the toner particle, wherein
the organic-inorganic composite particle
i) has a structure in which a second inorganic fine particle is embedded in a resin particle, and
ii) is contained in an amount of 0.5 mass % or more and 3.0 mass % or less based on the mass of the toner;
the first inorganic fine particle contains an inorganic oxide fine particle selected from the group consisting of a silica fine particle, a titanium oxide fine particle and an alumina fine particle; has a number average particle diameter (D1) of 5 nm or more and 25 nm or less, and contains the silica fine particle in an amount of 85 mass % or more based on the inorganic oxide fine particle.

### CROSS-REFERENCE TO RELATED APPLICATIONS

This application is a continuation of International Application No. PCT/JP2014/003951, filed Jul. 28, 2014 which claims the benefit of Japanese Patent Application No. 2013-158913, filed Jul. 31, 2013.

### BACKGROUND OF THE INVENTION

1. Field of the Invention

The present invention relates to a magnetic toner used in electrophotography, electrostatic recording and magnetic recording.

2. Description of the Related Art

At present, in copying machines and laser beam printers (hereinafter simply referred to as “printers”), a single-component development system using a magnetic toner has been widely used since it has advantages in cost and simpleness in an apparatus structure. For further improvement in speed and life of copying machines and LBPs, studies have been conducted from various angles of not only toner but also main-body machines.

For example, to deal with a high-speed operation, it is considered to increase the circumferential speed of a developer carrier (development sleeve). However, if the circumferential speed is increased, a magnetic toner is rubbed with a frictional charging member such as a development sleeve to facilitate embedding of an external additive in a magnetic toner surface. As a result, non-uniform charging occurs, which makes it difficult to provide images with an appropriate density. Although appropriate image density can be obtained by changing the developing bias to be applied between a photosensitive drum and a development sleeve (between SD), a sweeping phenomenon occurs, which makes it difficult to provide uniform images.

Herein, the sweeping phenomenon will be described. The sweeping refers to a phenomenon where a large amount of toner gathers at the rear end portion of a toner image formed by developing as electrostatic latent image on a photosensitive drum. When a developing bias is applied between a photosensitive drum and a development sleeve (between SD) during development, an electric field is generated. The toner deposited on the development sleeve surface reciprocally moves back and forth along electric lines of force formed by the electric field between the photosensitive drum and the development sleeve. Since the electric lines of force forms a barrel-form electric field, development force is partly applied to the toner within the development region corresponding to a rear end of a latent image rather than the upstream and center portion of the latent image. If such a toner image is formed, in a specific case where solid white images are continuously output after a solid black image is output, the image density of a rear half of the solid back image becomes higher than the other portion. If a high developing bias is applied, such image defect caused particularly by the sweeping phenomenon easily occurs.

To solve this problem, it is important to obtain an appropriate image density by application of a low developing bias and thus a magnetic toner capable of maintaining stable charge even in a high-speed machine is required. For this, in order to maintain charge by suppressing embedding of an external additive in a magnetic toner surface, many attempts have been made to use a large particle-diameter external additive. Since the large particle-diameter external additive has a large particle diameter and the contact area to a toner surface is large, impulse per unit-surface area of a toner can be reduced, with the result that embedding in the toner surface can be suppressed compared to a small particle-diameter external additive.

However, a conventional large particle-diameter external additive is known to have an adverse effect on low-temperature fixability of a toner. Since a large particle-diameter external additive is present on a toner surface, the interval between toner particles increases, integration of toner particles by thermofusion and fixation of toner on paper hardly occur. In order for a toner to deal with particularly a high-speed operation, there was still room for improvement. In addition, there was still room for improvement of sweeping, which is caused by a phenomenon where an appropriate image density cannot be obtained by application of a low developing bias due to change in deposition force of a toner.

To deal with such a problem, Japanese Patent Application Laid-Open No. 2007-293043 discloses that the total coverage ratio of a toner core particle with an external additive is controlled to stabilize a development/transfer step. Indeed, a certain effect is obtained on a specific toner core particle by controlling the theoretical coverage ratio calculated. However, the actual deposition state of an external additive often greatly differs from the calculation value obtained under the assumption that a toner particle is true spherical. Particularly, in a magnetic toner, it was completely insufficient to have the effect of the present invention, unless the actual deposition state of an external additive was controlled.

Japanese Patent Application Laid-Open No. 2005-202131 and International Publication No. WO 2013/063291 propose that a large particle-diameter external additive is added to suppress embedding of the external additive, thereby improving long-term stability. Also in these cases, there is room for improvement in order to have not only low-temperature fixability but also charge stability at the same time.

As described above, to deal with a high-speed operation, addition of a large particle-diameter external additive is effective but produces many harmful effects. Further countermeasure has been required.

### SUMMARY OF THE INVENTION

The present invention is directed to providing a toner which can overcome the aforementioned problems, and more specifically, to provide a toner easily applicable to high speed operation and attaining a long life by providing a stable image density during long-time use with less occurrence of a sweeping phenomenon; and at the same time, exerting excellent low-temperature fixability.

According to one aspect of the present invention, there is provided a magnetic toner comprising a toner particle comprising a binder resin and a magnetic member, and a first inorganic fine particle and an organic-inorganic composite particle on the surface of the toner particle,

wherein
the organic-inorganic composite particle
i) has a structure in which a second inorganic fine particle is embedded in a resin particle, and
ii) is contained in an amount of 0.5 mass % or more and 3.0 mass % or less based on the mass of the toner;
the first inorganic fine particle
i) contains an inorganic oxide fine particle selected from the group consisting of a silica fine particle, a titanium oxide fine particle and an alumina fine particle with the proviso that the silica fine particle is contained in an amount of 85 mass % or more based on the inorganic oxide fine particle, and
ii) has a number-average particle diameter (D1) of 5 nm or more and 25 nm or less; and
when the coverage ratio of the toner-particle surface with the first inorganic fine particle is represented by “coverage ratio A (%)” and the coverage ratio of the toner-particle surface with the first inorganic fine particle fixed onto the toner-particle surface is represented by “coverage ratio B (%)”, the coverage ratio A is 45.0% or more and 70.0% or less and the ratio (B/A) of coverage ratio B to coverage ratio A is 0.50 or more and 0.85 or less.

The present invention can provide a toner easily applicable to a high speed operation and attaining a long life by providing a stable image density during long-time use with less occurrence of a sweeping phenomenon; and at the same time, exerting excellent low-temperature fixability.

Further features of the present invention will become apparent from the following description of exemplary embodiments with reference to the attached drawings.

### BRIEF DESCRIPTION OF THE DRAWINGS

FIG. 1 is a graph illustrating the relationship between the addition amount of silica (parts by mass) and coverage ratio.

FIG. 2 is a graph illustrating the relationship between the addition amount of silica (parts by mass) and coverage ratio.

FIG. 3 is a graph illustrating the relationship between coverage ratio and static friction coefficient.

FIG. 4 is a schematic view illustrating a mixing apparatus, which can be used for external addition of an inorganic fine particle.

FIG. 5 is a schematic view of the structure of a stirring member used in a mixing apparatus.

FIG. 6 is a view illustrating an image-forming apparatus.

FIG. 7 is a graph illustrating the relationship between ultrasonic dispersion time and coverage ratio.

### DESCRIPTION OF THE EMBODIMENTS

Preferred embodiments of the present invention will now be described in detail in accordance with the accompanying drawings.

To suppress sweeping in the late period of long-time use, it is necessary to maintain charge of a magnetic toner. It is known that if a toner is negatively charged, highly negatively charged silica is generally used as an external additive. However, it is insufficient if the addition amount of silica is only increased. To describe it more specifically, small particle-diameter silica tends to have a secondary agglomerated particle. If the surface of a magnetic toner is covered with silica having a large amount of secondary agglomerated particle, charge of a magnetic toner will be changed when the silica dissociates. As a result of studies conducted by the present inventors, it was found that, particularly in a magnetic toner applicable to high-speed operation and attaining a long life, it is necessary to appropriately control the coverage state with a small particle-diameter external additive and fixation state thereof.

In contrast, to deal with a high-speed operation, it is necessary to fix a toner onto paper in a short time during which a paper sheet passes through a nip of a fixing unit. When the toner surface is covered with an inorganic fine particle external additive, an interface is generally formed between fused toner containing a resin as a main component and the inorganic fine particle not fused, in fixing and the inorganic fine particle acts so as to inhibit integration with the toner. As a result, the interface between the inorganic fine particle and fused toner acts as a point from which breakage of a toner agglomeration on paper starts when physical force is externally applied and is considered to be an obstacle in attaining low-temperature fixability. The present inventors focused the shape of a large particle-diameter external additive. As a result, they found that it is able to realize low-temperature fixability by using an organic-inorganic composite particle. Particularly, in a magnetic toner, since it differs from a color toner, it is not necessary to completely fuse a toner particle for mixing colors. Because of this, sufficient fixability can be obtained even if the surfaces of magnetic toner particles are mutually bound.

To stabilize the charge of a magnetic toner, it is necessary to control the ratio (B/A), provided that the coverage ratio of the toner-particle surface with a first inorganic fine particle is “coverage ratio A (%)” and the coverage ratio of the toner-particle surface with a first inorganic fine particle fixed onto the toner-particle surface is “coverage ratio B (%)”. Furthermore, even if a large particle-diameter external additive is used, unless the deposition state thereof on the magnetic toner is controlled so as not to change, the charge of a magnetic toner and flowability thereof may change. Furthermore, to obtain low-temperature fixability even if the toner is used for a long time, it is necessary to control the deposition state of a large particle-diameter external additive so as not to change.

For this, in a magnetic toner, it is necessary that an organic-inorganic composite particle having a structure, in which a second inorganic fine particle is embedded in a resin particle, is present in the surface of a magnetic toner particle.

The organic-inorganic composite particle is a material having not only properties as an organic material but also properties as an inorganic material. Suppression of sweeping and low-temperature fixability can be attained at the same time by appropriately controlling the coverage state with a small particle-diameter external additive and fixation state thereof and using an organic-inorganic composite particle. The inventors consider the reasons thereof as follows.

In order to stabilize charge of a magnetic toner, a small particle-diameter external additive must fixed onto the magnetic toner surface such that coverage ratio A of the magnetic toner is 45.0% or more and 70.0% or less, and the ratio (B/A) of coverage ratio B to coverage ratio A is 0.50 or more and 0.85 or less. This shows a more or less uniform fixation state of external additive with less amount of secondary agglomeration of small particle-diameter external additive. To describe it more specifically, particles of the small particle-diameter external additive are present in the magnetic toner surface while keeping almost the same height from the magnetic toner surface. Although the deposition state of the small particle-diameter external additive is like this, if a large particle-diameter external additive is composed of an organic-inorganic composite particle, the organic-inorganic composite particle is suppressed from rolling on the magnetic toner surface, with the result that stable frictional electrification is conceivably obtained.

Since a conventional small particle-diameter external additive is present in such a state that the particles are partly agglomerated, the toner surface is uneven due to the presence of the small particle-diameter external additive. In this case, although a conventional large particle-diameter external additive does not roll; however, the coverage state of the small particle-diameter external additive is nonuniform. For this reason, the charge is too unstable to deal with a high-speed operation.

In contrast, low-temperature fixability is considered as follows. The obstacle of low-temperature fixability is suppressed by filling the interface produced between a fused toner and a first inorganic fine particle with an organic component of an organic-inorganic composite particle, in a fixing process. Furthermore, since an organic-inorganic composite particle has a structure in which a second inorganic fine particle is embedded in a resin particle, even if a magnetic toner has a surface on which a small particle-diameter external additive is deposited while keeping almost the same height from the surface, the magnetic toner scarcely rolls. Because of this, it is considered that low-temperature fixability does not significantly change even if the toner is used for a long time.

The addition amount of an organic-inorganic composite particle is required to be 0.5 mass % or more and 3.0 mass % or less based on the total mass of the toner.

It is preferable that the addition amount (parts by mass) of an organic-inorganic composite particle falls within the aforementioned range, since low-temperature fixability is not damaged and even if the constitution thereof is developed for satisfying a high-speed operation for long-time use, sufficient charge and flowability can be imparted to the toner. It is preferable that the addition amount (parts by mass) of an organic-inorganic composite particle is 0.8 mass % or more and 2.5 mass % or less, since the above effect is more efficiently exerted.

As an indicator showing thermal characteristic of an external additive particle in fixing, the present inventors focused on volumetric specific heat of the external additive. The volumetric specific heat refers to an amount of heat required for changing unit-temperature of a substance per unit-volume. The organic-inorganic composite particle preferably has a volumetric specific heat at 80° C. of 2900 kJ/(m³·° C.) or more and 4200 kJ/(m³·° C.) or less.

As the same indicator, specific heat is known, which refers to an amount of heat required for changing unit-temperature of a substance per unit-mass. However, the present inventors considered that volumetric specific heat is more preferable indicator in the study of the present invention. The present inventors considered that if the volumetric specific heat of an external additive is sufficiently low, thermofusion of a toner core in fixing will not be damaged and sufficient low-temperature fixability of a toner can be attained. This is because if a constant amount of heat is externally applied, a toner having a smaller volumetric specific heat more quickly increases in temperature to quickly fuse a toner core. This is because the present inventors consider that in studying thermal characteristic under precondition where the surface of a toner covered with an external additive having a predetermined particle diameter in a predetermined coverage ratio, in other words, under the condition where the external additive is present in a constant total volume, volumetric specific heat indicating heat capacity per unit volume is proper.

When the specific heat of an external additive is focused under the constant volume conditions, the relationship may sometimes be reversed. For example, specific heats of soda glass and a polystyrene resin described in literatures are 750 J/(kg·° C.) and 1340 J/(kg·° C.), respectively. Based on the specific heat, it is considered that if soda glass is used as an external additive, the soda glass is easily warmed and would not damage thermofusion of a toner core in fixing. However, in consideration of an actual system, volumetric specific heats are compared based on the same volume, the volumetric specific heats of the soda glass and the polystyrene resin are 1943 kJ/(m³·° C.) and 1407 kJ/(m³·° C.), respectively. In the way, the relationship is reversed. Since such a case is present, it was determined that volumetric specific heat is a preferable indicator in this study.

It is preferable that the volumetric specific heat of an organic-inorganic composite particle falls within the aforementioned range, because thermofusion of a toner core in fixing is not damaged and sufficient low-temperature fixability of the toner can be obtained. It is preferable that the volumetric specific heat is 3100 kJ/(m³·° C.) or more and 4200 kJ/(m³·° C.) or less since these effects can be satisfactorily exerted. If the volumetric specific heat is set within the range, the effects of embedding an external additive and thermofusion of a toner particle are more easily exerted.

Note that volumetric specific heat is a thermal characteristic value which changes according to the temperature of an object. In consideration of the temperature of paper in a heat fixation step of a common printer and copying machine, the present inventors consider that 80° C. is the most suitable value in expressing thermal change of a toner in an actual system.

It is preferable that an organic-inorganic composite particle has a plurality of convexes in the surface due to the inorganic fine particles b, and a number average particle diameter of 50 nm or more and 200 nm or less.

If the number average particle diameter falls within the aforementioned range, a large particle-diameter external additive is hardly embedded even if a strong physical load is applied in a long-time operation by a high-speed electrophotographic process and can impart a sufficient flowability and electrostatic properties to a toner as an external additive until the end of the operation. It is preferable that a number average particle diameter is 70 nm or more and 130 nm or less, since these effects are satisfactorily produced within the range. If the number average particle diameter falls within the range, effects of embedding an external additive and imparting toner flowability are more easily produced.

The organic-inorganic composite particle can be produced, for example, according to Examples of Japanese Patent Application Laid-Open No. 2013-92748.

The resin particle component of the organic-inorganic composite particle can be a vinyl resin in view of electrostatic properties. Furthermore, the second inorganic fine particle can be a silica fine particle.

The organic-inorganic composite particle can have a shape coefficient SF-1 of 100 or more and 150 or less, when measured at a magnification of 200,000. The shape coefficient, SF-1, is an indicator expressing the degree of circularity of a particle. If the value is 100, a particle is a true circle. As the numerical value increases, the shape becomes far away from a circle and closer to an indefinite shape.

The organic-inorganic composite particle can have a shape coefficient SF-2 of 103 or more and 150 or less when measured at a magnification of 200,000. The shape coefficient, SF-2, is an indicator expressing the degree of unevenness of a particle. If the value is 100, a particle is a true circle. As the numerical value increases, the degree of unevenness increases.

If SF-1 and SF-2 fall within the aforementioned ranges, an organic-inorganic composite particle is anchored onto a toner surface because of the effect of unevenness of the surface. Because of this, even if toner particles are stirred and repeatedly hit to each other during long time use, the phenomenon where an organic-inorganic composite particles are gathered in local portions such as concaves in the toner-particle surface does not rarely occur. This is preferable to attain suppression of sweeping and low-temperature fixability at the same time.

Furthermore, provided that the coverage ratio of the toner-particle surface with the first inorganic fine particle is coverage ratio A (%) and the coverage ratio of the toner-particle surface with the first inorganic fine particle fixed onto the toner-particle surface is coverage ratio B (%), it is necessary that the magnetic toner of the present invention has a coverage ratio A of 45.0% or more and 70.0% or less and the ratio (B/A) of the coverage ratio B to coverage ratio A is 0.50 or more and 0.85 or less.

Furthermore, the above coverage ratio A can be 45.0% or more and 65.0% or less and B/A is 0.55 or more and 0.80 or less.

In magnetic toner quickly charged as mentioned above, if coverage ratio A and B/A, which show the coverage state with the external additives, satisfy the predetermined ranges, sweeping can be suppressed in the late period of long time operation.

The reason for this is not elucidated but speculated as follows.

In a development step, a magnetic toner comes into contact with a development blade and a development sleeve at the portion at which the development blade is in contact with the development sleeve. At this time, the magnetic toner is charged by friction. If the magnetic toner uncharged remains on the development sleeve and the development blade, the magnetic toner is repeatedly rubbed. Particularly in a high speed machine, embedding of an external additive into a magnetic toner surface is accelerated and the magnetic toner is non-uniformly charged. At this state, if a developing bias is changed, an image density can be obtained; however if the developing bias is increased to accelerate development, a sweeping phenomenon occurs.

However, in the magnetic toner of the present invention, since coverage ratio A of the magnetic toner-particle surface with an inorganic fine particle is as high as 45.0% or more, van der Waals force and electrostatic deposition force between the magnetic toner and the member in contact with the toner are low, with the result that the magnetic toner easily separates from the development sleeve. Because of this, the magnetic toner particles rarely migrate on the development sleeve and thus non-uniform charge rarely occurs. Furthermore, since embedding of an external additive in the magnetic toner surface caused by mutual contact between magnetic toner particles rarely occurs, non-uniform charge rarely occurs. If coverage ratio A is increased to more than 70.0%, a large amount of inorganic fine particles must be added. This case is not preferable because even if any method is used for treating an external additive, image defects (longitudinal lines) are easily produced by free inorganic fine particles. This case is neither preferable for obtaining low-temperature fixability attaining a high-speed operation.

Herein, coverage ratio A, coverage ratio B, and the ratio [B/A] of the coverage ratio B to coverage ratio A can be obtained by the following methods.

In the present invention, coverage ratio A is the ratio of coverage with inorganic fine particles including easily removable inorganic fine particles; whereas coverage ratio B is the ratio of coverage with inorganic fine particles, which are fixed onto a magnetic toner-particle surface and would not be removed by the removal operation (described later). The inorganic fine particle involved in coverage ratio B is half-embedded and fixed onto a magnetic toner-particle surface, and thus, even if shear force is applied to a magnetic toner on a development sleeve and an electrostatic latent image carrier, it is considered that the magnetic toner would not move.

Whereas the inorganic fine particle involved in coverage ratio A includes the inorganic fine particle fixed as mentioned above and an inorganic fine particle present above the fixed inorganic fine particle and having relatively high degree of freedom.

The aforementioned effect of reducing the van der Waals force and electrostatic deposition force is produced by inorganic fine particles present between magnetic toner particles and between the magnetic toner and each of members. It is considered that increasing coverage ratio A is important in view of the effect.

The van der Waals force (F) produced between a flat-plate and a particle is represented by the following expression.

F=H×D/(12Z²)

where H represents Hamaker constant, D represents size of particle, and Z represents the distance between the particle and the flat-plate.

It is generally said that if the distance Z is large, attractive force works, if the distance Z is small, a repulsive force works. Since the distance Z is irrelevant to the state of magnetic toner surface, Z is regarded as a constant.

From the above expression, it is found that van der Waals force (F) is proportional to the size of particle in contact with the flat-plate. If this is applied to the case of a magnetic toner surface, van der Waals force (F) is smaller in the case where an inorganic fine particle smaller than a magnetic toner particle is in contact with the flat-plate rather than the magnetic toner particle is in contact with the flat plate. In short, the van der Waals force is smaller in the case a magnetic toner particle is indirectly in contact with a development sleeve and a development blade via an inorganic fine particle serving as an external additive than the case where a magnetic toner particle is directly in contact with the development sleeve and the development blade.

The electrostatic deposition force can be also said as reflection force. It is known that the reflection force is generally proportional to the square of charge (q) of a particle and inversely proportional to the square of distance.

When the magnetic toner is charged, not the inorganic fine particle but the magnetic toner-particle surface is charged. Because of this, reflection force becomes smaller with the distance between a magnetic toner-particle surface and a flat-plate (a development sleeve and a development blade in the invention) increases.

More specifically, in the magnetic toner surface, since a magnetic toner particle is in contact with a flat-plate via an inorganic fine particle, there is a certain distance between the magnetic toner-particle surface and the flat-plate. Thus, the reflection force reduces.

As mentioned above, an inorganic fine particle is present on a magnetic toner-particle surface and a magnetic toner is in contact with a development sleeve or a development blade via an inorganic fine particle. Therefore, van der Waals force and reflection force produced between the magnetic toner and the development sleeve or development blade reduce. In other words, the deposition force between a magnetic toner and a development sleeve or a development blade reduces.

Whether a magnetic toner particle is directly in contact with a development sleeve or a development blade and whether they are in contact with each other via an inorganic fine particle is determined depending upon how large area of the magnetic toner-particle surface is covered with an inorganic fine particle, in other words, the coverage ratio with an inorganic fine particle.

If the coverage ratio with an inorganic fine particle is high, the chance of a magnetic toner particle directly in contact with a development sleeve or development blade decreases. As a result, it is conceivably difficult for the magnetic toner to attach to a development sleeve or a development blade. In contrast, if the coverage ratio with an inorganic fine particle is low, it is easy for the magnetic toner to attach to a development sleeve or a development blade, with the result that the magnetic toner tends to accumulate on the development sleeve and near the development blade.

The coverage ratio of a magnetic toner with an inorganic fine particle can be calculated as a theoretical coverage ratio according to the computational expression described in Japanese Patent Application Laid-Open No. 2007-293043, on the assumption that the inorganic fine particle and the magnetic toner are true spherical. However, as is often the case, the inorganic fine particle and the magnetic toner are not true spherical. In addition, an inorganic fine particle is sometimes present in agglomeration-state in a toner-particle surface. In the present invention, the theoretical coverage ratio obtained by the above method was not employed.

Then the present inventors observed the surface of a magnetic toner by a scanning electron microscope (SEM) to obtain the coverage ratio of a magnetic toner-particle surface actually covered with a first inorganic fine particle.

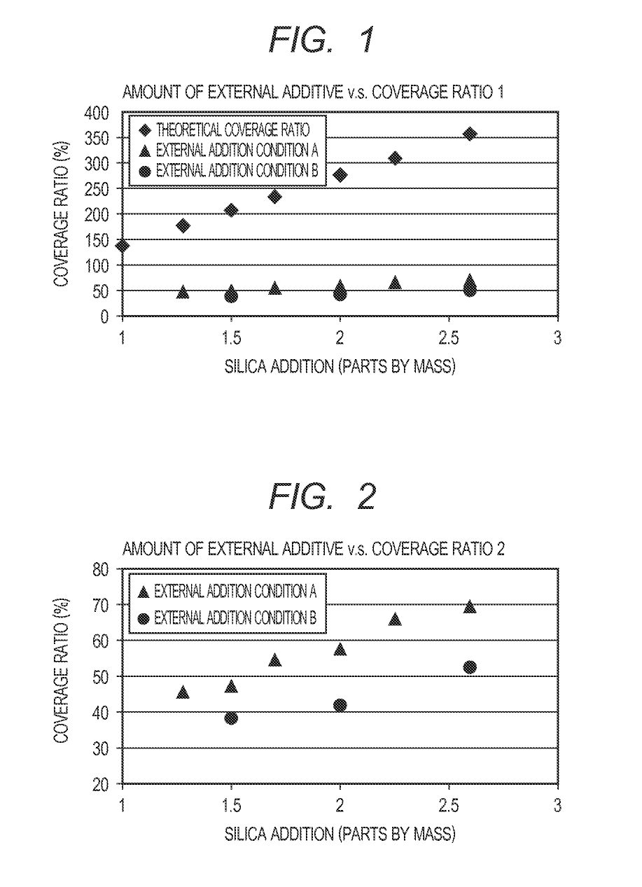

For example, to a magnetic toner particle (the content of a magnetic member is 43.5 mass %) (100 parts by mass) having a volume average particle diameter (Dv) of 8.0 μm and obtained by a grinding method, a silica fine particle was added in different addition amounts (addition amount of silica (parts by mass)) to obtain magnetic toners. The theoretical coverage ratio and actual coverage ratio of the obtained magnetic toners were obtained (see FIG. 1, FIG. 2). Note that as the silica fine particle, a silica fine particle having a volume average particle diameter (Dv) of 15 nm was used.

In computationally obtaining the theoretical coverage ratio, the true-specific gravity of the silica fine particle was regarded as 2.2 g/cm³ and the true-specific gravity of the magnetic toner was regarded as 1.65 g/cm³. As the silica fine particle and magnetic toner particle, mono-dispersed silica fine particle and magnetic toner particle having a particle diameter of 15 nm and 8.0 μm, respectively, were used.

As shown in FIG. 1, as the addition amount of the silica fine particle is increased, the theoretical coverage ratio exceeds 100%. In contrast the actual coverage ratio increases as the addition amount of the silica fine particle increases, but never exceeds 100%. This is because a part of the silica fine particles is present in an agglomeration state in the magnetic toner surface or greatly influenced by the fact that the silica fine particle is not true spherical.

Furthermore, according to studies by the present inventors, it was found that even if the addition amounts of the silica fine particle are the same, if methods for adding external additives differ, the coverage ratios vary. In other words, it is impossible to obtain the coverage ratio solely from the addition amount of the silica fine particle (see FIG. 2). Note that according to external addition condition A, mixing is performed by use of the apparatus shown in FIG. 4 at 1.0 W/g, for a treatment time of 5 minutes. In external addition condition B, mixing is performed by Henschel mixer FM10C (manufactured by Mitsui Miike Kakoki Kabushiki Kaisha) at 4000 rpm for treatment time of 2 minutes.

For the reason, the present inventors employed the coverage ratio with the first inorganic fine particle obtained by observation of a magnetic toner surface by SEM.

As mentioned above, it is considered that the deposition force to a member can be reduced by increasing coverage ratio with the first inorganic fine particle. Then, the coverage ratio with the first inorganic fine particle and the deposition force to a member were studied.

The relationship between the coverage ratio of a magnetic toner and deposition force to a member was indirectly estimated by measuring the static friction coefficient between each of the spherical polystyrene particles, which was covered with silica fine particle in a different coverage ratio, and an aluminum substrate.

More specifically, using spherical polystyrene particles (weight average particle diameter (D4)=7.5 μm) covered with a silica fine particle in different coverage ratios (coverage ratio obtained by SEM observation), the relationship between the coverage ratio and the static friction coefficient was obtained.

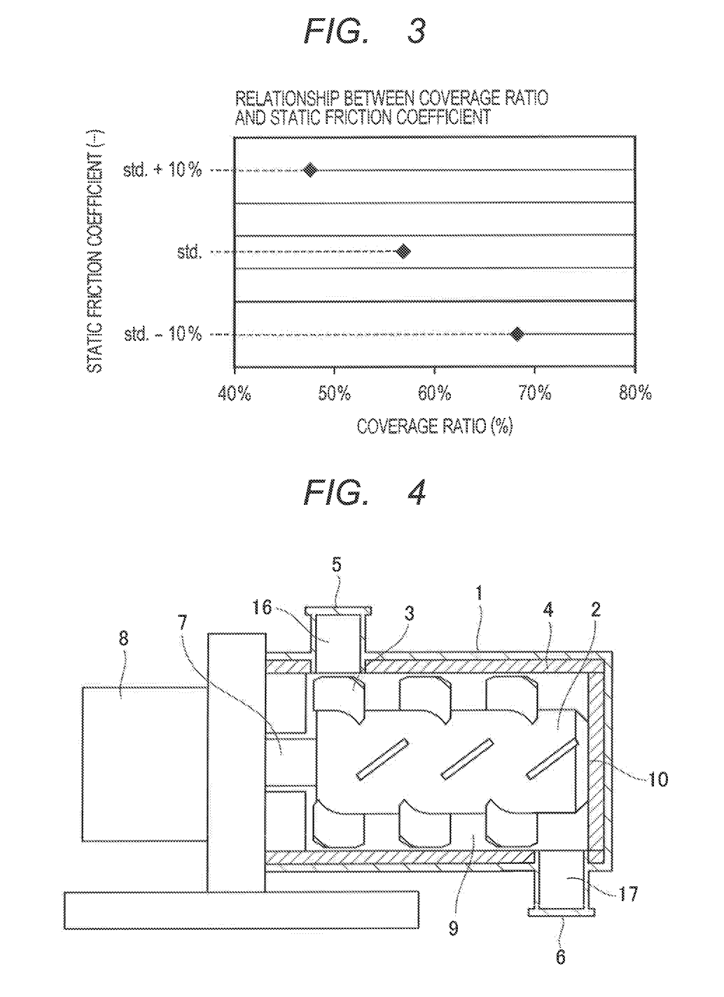

More specifically, onto an aluminum substrate, a spherical polystyrene particle to which a silica fine particle was added was pressed. The substrate was moved right and left while changing pressing force. Based on the stress at this time, a static friction coefficient was calculated. This was repeated with respect to spherical polystyrene particles different in coverage ratio. The relationship between the coverage ratio and the static friction coefficient obtained is shown in FIG. 3.

The static friction coefficient obtained in the manner is considered to be correlated with the sum of van der Waals force and reflection force acting between the spherical polystyrene particle and the substrate. From FIG. 3, it is found that as the coverage ratio of the silica fine particle increases, the static friction coefficient tends to decrease. More specifically, it is estimated that a magnetic toner having high coverage ratio with a first inorganic fine particle is low in deposition force to a member.

Next, the ratio of B/A of 0.50 or more and 0.85 or less means that a certain amount of the inorganic fine particles a are fixed onto a magnetic toner-particle surface and an appropriate amount of the inorganic fine particle is present in such a state that they can be easily removed. Probably, since the removable first inorganic fine particle may slip over the first inorganic fine particle fixed to produce a bearing effect, the cohesive force between magnetic toner particles is considered to drastically decrease.

As a result of the studies conducted by the present inventors, the aforementioned deposition force reducing effect and bearing effect are produced by the first inorganic fine particle fixed and the easily removable first inorganic fine particle. In addition, it was found that these effects can be obtained in maximum when an inorganic fine particle is relatively small, i.e., a primary-particle number average particle diameter (D1) of about 50 nm or less. Thus, in calculating coverage ratio A and coverage ratio B, a first inorganic fine particle having a primary-particle number average particle diameter (D1) of 50 nm or less was focused.

In the magnetic toner of the present invention, the deposition force between the magnetic toner and each of the members can be reduced as well as the cohesive force between the magnetic toner particles can be drastically reduced by satisfying coverage ratio A and B/A within a predetermined range. As a result, at a portion at which a development blade is in contact with a development sleeve, the chance for individual magnetic toner particles to be in contact with the development blade and development sleeve can be increased. Due to this, it is conceivable that the magnetic toner is uniformly charged.

If the ratio of B/A is less than 0.50, a small particle-diameter external additive removes and removal of an organic-inorganic composite particle tends to be induced, with the result that sweeping and low-temperature fixability deteriorate. In contrast, if the ratio of B/A exceeds 0.85, since the bearing effect is hardly obtained, deposition force increases. Since it is necessary to increase development contrast in order to obtain an appropriate image density, sweeping easily occurs.

In the present invention, the variation coefficient of coverage ratio A is preferably 10.0% or less and more preferably is 8.0% or less. The variation coefficient of coverage ratio A of 10.0% or less means that coverage ratio A is extremely equal between magnetic toner particles and within magnetic toner particles. It is rather preferable to make equal coverage ratio A since cohesive force between toner particles can be reduced.

A method for controlling the above variation coefficient to be 10.0% or less is not particularly limited; however, an external addition apparatus and method (described later) can be used since a metal oxide fine particle such as a silica fine particle can be highly dispersed on a magnetic toner-particle surface.

The magnetic toner of the present invention has a first inorganic fine particle on a magnetic toner-particle surface.

A first inorganic fine particle contains an inorganic oxide fine particle selected from the group consisting of a silica fine particle, a titanium oxide fine particle and an alumina fine particle. However, the silica fine particle is necessarily contained in an amount of 85 mass % or more based on the inorganic oxide fine particle and preferably contained in an amount of 90 mass % or more based on the inorganic oxide fine particle. This is because a silica fine particle is most excellent in providing electrostatic properties and flowability in a balanced manner as well as excellent in reducing cohesive force. Furthermore, the first inorganic fine particle satisfies a number average particle diameter (D1) of 5 nm or more and 25 nm or less.

Although the reason why a silica fine particle is excellent in reducing cohesive force between toner particles is not exactly known, it is presumed that the aforementioned bearing effect produced by mutually sliding the silica fine particles may greatly contribute.

If the primary particle number average particle diameter (D1) of the first inorganic fine particle falls within the above range, the coverage ratio A, and the ratio B/A can be appropriately controlled and the aforementioned deposition force reduction and the bearing effect can be obtained. Furthermore, since rolling of an organic-inorganic composite particle can be reduced, even if a toner is used for a long time, low-temperature fixability can be suppressed from changing.

A first inorganic fine particle to be used in the present invention is preferably treated in a hydrophobizing process and particularly preferably treated in a hydrophobizing process so as to obtain a hydrophobicity (measured by titration test with methanol) of 40% or more and more preferably 50% or more.

As a method for the hydrophobizing treatment, a treatment method with e.g., an organic silicon compound, a silicone oil and a long-chain fatty acid are mentioned.

Examples of the organic silicon compound include hexamethyldisilazane, trimethylsilane, trimethylethoxysilane, isobutyltrimethoxysilane, trimethylchlorosilane, dimethyldichlorosilane, methyltrichlorosilane, dimethylethoxysilane, dimethyldimethoxysilane, diphenyldiethoxysilane and hexamethyldisiloxane. These are used singly or as a mixture of two types or more.

Examples of the silicone oil include dimethylsilicone oil, methylphenylsilicone oil, α-methylstyrene modified silicone oil, chlorophenylsilicone oil and fluorine modified silicone oil.

As the long-chain fatty acid, a fatty acid having 10 to 22 carbon atoms can be preferably used and a linear or branched fatty acid may be used. Furthermore, both of a saturated fatty acid and an unsaturated fatty acid can be used.

Of them, a linear saturated fatty acid having 10 to 22 carbon atoms is extremely preferable since it can uniformly treat the surface of a first inorganic fine particle.

Examples of the linear saturated fatty acid include capric acid, lauric acid, myristic acid, palmitic acid, stearic acid, arachidic acid and behenic acid.

A first inorganic fine particle is preferably treated with a silicone oil and more preferably treated with an organic silicon compound and a silicone oil. This is because hydrophobicity can be suitably controlled.

As a method for treating an inorganic fine particle with a silicone oil, for example, a method of directly mixing an inorganic fine particle treated with an organic silicon compound and a silicone oil by use of a mixer such as Henschel mixer, and a method of spraying silicone oil to an inorganic fine particle. Alternatively, a method of dissolving or dispersing a silicone oil in an appropriate solvent, adding an inorganic fine particle, mixing them and removing the solvent may be used.

The treatment amount of silicone oil is preferably 1 part by mass or more and 40 parts by mass or less and more preferably 3 parts by mass or more and 35 parts by mass or less relative to a first inorganic fine particle (100 parts by mass) in order to obtain satisfactory hydrophobicity.

A first inorganic fine particle according to the present invention preferably has a specific surface area (BET specific surface area, measured by BET method based on nitrogen adsorption) of 20 m²/g or more and 350 m²/g or less, and particularly preferably 25 m²/g or more and 300 m²/g or less, in order to provide satisfactory flowability to a magnetic toner.

The specific surface area (BET specific surface area) is measured by the BET method based on nitrogen adsorption according to JISZ8830 (2001). As the measurement apparatus, “automatic specific surface area/fine pore distribution measurement apparatus TriStar3000 (manufactured by Shimadzu Corporation)” employing a constant-volume gas adsorption method as a measurement system is used.

Herein, the addition amount of a first inorganic fine particle is preferably 1.5 parts by mass or more and 3.0 parts by mass or less relative to magnetic toner particle (100 parts by mass), particularly preferably 1.5 parts by mass or more and 2.6 parts by mass or less, and further preferably 1.8 parts by mass or more and 2.6 parts by mass or less.

It is preferable that the addition amount of the first inorganic fine particle falls within the above range, since the coverage ratio A and the ratio of B/A can be appropriately controlled, and the addition amount is also preferable in view of image density, sweeping and suppression of development line.

In the present invention, as the binder resin of a magnetic toner, a vinyl resin, a polyester resin, an epoxy resin and a polyurethane resin are mentioned, but not particularly limited and a conventionally known resin can be used. In view of attaining charging and fixability at the same time, a polyester resin or a vinyl resin is preferably contained. Particularly, as a main binder resin, a polyester resin is preferably used in view of low-temperature fixability. The composition of the above polyester resin is as follows.

As a divalent alcohol component constituting a polyester resin, ethylene glycol, propylene glycol, butane diol, diethylene glycol, triethylene glycol, pentane diol, hexane diol, neopentyl glycol, hydrogenation bisphenol A, a bisphenol represented by the following formula (A) and a derivative thereof and a diol represented by the following formula (B) are mentioned.

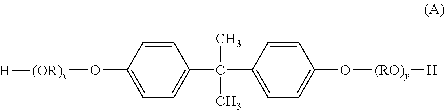

where R is an ethylene group or a propylene group; x and y are each an integer of 0 or more; and an average value of x+y is 0 or more and 10 or less.

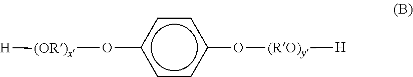

where R′ is

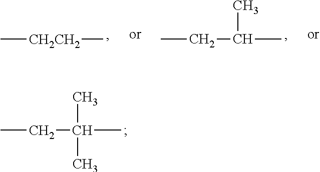

x′ and y′ are each an integer of 0 or more; and an average value of x′+y′ is 0 or more and 10 or less.

Examples of the divalent acid component constituting a polyester resin as mentioned above include benzene carboxylic acids such as phthalic acid, terephthalic acid, isophthalic acid and phthalic anhydride; alkyldicarboxylic acids such as amber acid, adipic acid, sebacic acid and azelaic acid; alkenylsuccinic acids such as n-dodecenyl succinic acid; and unsaturated dicarboxylic acids such as fumaric acid, maleic acid, citraconic acid and itaconic acid.

Furthermore, a polyhedric (trivalent or more) alcohol component serving as a crosslinking component and a trivalent or more acid component may be used singly or in combination.

Examples of the trivalent or more polyhedric alcohol components include sorbitol, pentaerythritol, dipentaerythritol, tripentaerythritol, butane triol, pentane triol, glycerol, methyl propane triol, trimethylolethane, trimethylolpropane and trihydroxybenzene.

In the present invention, examples of trivalent or more polyvalent carboxylic acid components include trimellitic acid, pyromellitic acid, benzene tricarboxylic acid, butane tricarboxylic acid, hexane tricarboxylic acid and a tetracarboxylic acid represented by the following formula (C).

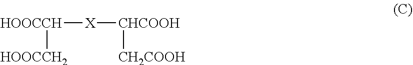

where X represents an alkylene group or an alkenylene group having one or more side chains having 3 or more carbon atoms.

As long as dielectric properties in the present invention are satisfied, a styrene resin may be added to a binder resin. Examples of the styrene resin include a polystyrene and styrene copolymers such as a styrene-propylene copolymer, a styrene-vinyl toluene copolymer, a styrene-methyl acrylate copolymer, a styrene-ethyl acrylate copolymer, a styrene-butyl acrylate copolymer, a styrene-octyl acrylate copolymer, a styrene-methyl methacrylate copolymer, a styrene-ethyl methacrylate copolymer, a styrene-butyl methacrylate copolymer, a styrene-octyl methacrylate copolymer, a styrene-butadiene copolymer, a styrene-isoprene copolymer, a styrene-maleic acid copolymer and a styrene-maleate copolymer. These can be used singly or in combination of a plurality of types.

The glass transition temperature (Tg) of the magnetic toner of the present invention is preferably 40° C. or more and 70° C. or less. If the glass transition temperature is 40° C. or more and 70° C. or less, storage stability and durability can be improved while maintaining satisfactory fixability.

To the magnetic toner of the present invention, if necessary, wax may be added in order to improve fixability. As the wax, all known waxes can be used. Examples of the waxes include petroleum waxes such as wax paraffin wax, microcrystalline wax and petroleum jelly and derivatives thereof, montan wax and derivatives thereof, hydrocarbon waxes obtained by the Fischer-Tropsch method and derivatives thereof, polyolefin waxes represented by polyethylene and polypropylene and derivatives thereof, natural waxes such as carnauba wax and candelilla wax and a derivative thereof and ester waxes. Herein, the derivatives include oxides, block copolymers with vinyl monomers and graft-modified products. Furthermore, as ester waxes, not only a mono-functional ester wax and a bi-functional ester wax but also multifunctional ester waxes such as a tetra-functional ester wax and a hexa-functional ester wax can be used.

The toner of the present invention may contain a crystalline resin.

An example of the crystalline resin, a crystalline polyester may be mentioned. The crystalline polyester is preferably formed at least from an aliphatic diol having 4 or more and 20 or less carbon atoms and a polyvalent carboxylic acid as raw materials.

Furthermore, the aliphatic diol is preferably linear. Because of linear chain, crystallinity of the resin can be easily increased.

As the aliphatic diol that can be used in the present invention, the following compounds can be mentioned but not particularly limited to these. They may be used as a mixture. Examples thereof include 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol and 1,20-eicosanediol.

Furthermore, an aliphatic diol having a double bond can be used. Examples of the aliphatic diol having a double bond include 2-butene-1,4-diol, 3-hexene-1,6-diol and 4-octene-1,8-diol.

In the present invention, examples of the magnetic member contained in a magnetic toner include iron oxides such as magnetite, maghemite and ferrite, metals such as iron, cobalt and nickel, alloys of these metals with a metal such as aluminium, copper, magnesium, tin, zinc, beryllium, calcium, manganese, selenium, titanium, tungsten and vanadium, and mixtures of these.

The particle of the magnetic member preferably has a primary-particle number average particle diameter (D1) of 2.00 μm or less and more preferably 0.05 μm to 0.50 μm.

The magnetic member preferably has the following magnetic properties under application of 795.8 kA/m: a coercive force (Hc) of 1.6 to 12.0 kA/m. An intensity of magnetization (σs) of 50 to 200 Am²/kg and more preferably 50 to 100 Am²/kg, and a residual magnetization (σr) of 2 to 20 Am²/kg.

The content of a magnetic member in a magnetic toner is 30 parts by mass or more and 120 parts by mass or less relative to a binder resin (100 parts by mass) and particularly preferably, 40 parts by mass or more and 110 parts by mass or less.

The content of a magnetic member in a magnetic toner can be measured by a thermal analysis apparatus, TGA Q5000IR, manufactured by PerkinElmer Co., Ltd. Measurement is performed by heating a magnetic toner at a temperature increasing rate of 25° C./minute from normal temperature to 900° C. under a nitrogen atmosphere. A reduction in mass of the magnetic toner by a temperature change from 100 to 750° C. is obtained and regarded as the mass of components of the magnetic toner excluding the magnetic member. The remaining mass is determined as the amount of magnetic member.

In the magnetic toner of the present invention, a charge control agent can be added. Note that the magnetic toner of the present invention can be a toner that can be negatively charged.

As a charge control agent for negative charge use, an organic metal complex and a chelate compound are effectively used. Examples thereof include monoazometal complexes; acetyl acetone metal complexes; and metal complexes of an aromatic hydroxycarboxylic acid or an aromatic dicarboxylic acid. Specific examples of a commercially available product thereof include Spilon Black TRH, T-77, T-95 (manufactured by Hodogaya Chemical Co., LTD.) and BONTRON (R) S-34, S-44, S-54, E-84, E-88, E-89 (manufactured by Orient Chemical Industries Co., Ltd).

These charge control agents can be used alone or in combination of two or more. Use amount of these charge control agents is preferably 0.1 to 10.0 parts by mass and more preferably 0.1 to 5.0 parts by mass based on the binder resin (100 parts by mass), in view of the charge amount of magnetic toner.

The magnetic toner of the present invention has a weight average particle diameter (D4) of preferably 6.0 μm or more and 10.0 μm or less and more preferably 7.0 μm or more to 9.0 μm or less, in view of balance between developability and fixability.

The magnetic toner of the present invention has an average degree of circularity of preferably 0.935 or more and 0.955 or less and more preferably 0.938 or more and 0.950 or less, from the viewpoint of suppressing charge-up.

In the magnetic toner of the present invention, the average degree of circularity thereof can be adjusted to fall within the above range by adjusting a method and conditions for producing a magnetic toner.

Now, the production method for the magnetic toner of the present invention will be described by way of examples; however the method is not limited to these examples.

The magnetic toner of the present invention can be produced by a production method known in the art. The production method is not particularly limited as long as coverage ratio A and B/A are adjusted by the method and preferably a step of adjusting the average degree of circularity is included in the method (in other words, production steps other than the step are not particularly limited).

As the production method, the following methods are preferably mentioned. First, a binder resin and a magnetic member, and, if necessary, other materials such as wax and a charge control agent, are sufficiently mixed by a mixer such as a Henschel mixer or a ball mill, then, melted, mixed and kneaded by a heat kneader such as a roll, a kneader and extruder. In this way, resins are mutually melted with each other.

After the obtained melt-kneaded product is cooled to solidify, the resultant product is subjected to rough grinding, fine grinding and classification. To the obtained magnetic toner particle, an external additives such as an inorganic fine particle is externally added to obtain a magnetic toner.

Examples of the mixer include a Henschel mixer (manufactured by NIPPON COKE & ENGINEERING, CO., LTD.); a super mixer (manufactured by KAWATA MFG Co., Ltd.); Ribocone (manufactured by OKAWARA CORPORATION); a nauter mixer, a turbulizer, a cyclone mix (manufactured by Hosokawa Micron Corporation); a spiral pin mixer (manufactured by Pacific Machinery & Engineering Co., Ltd); and LODIGE Mixer (manufactured by MATSUBO Corporation), NOBILTA (manufactured by HOSOKAWA MICRONE CORPORATION).

Examples of the kneader include a KRC kneader (manufactured by KURIMOTO LTD.); Buss co-kneader (manufactured by Buss); a TEM extruder (manufactured by TOSHIBA MACHINE CO., LTD); a TEX twin-screw kneader (manufactured by The Japan Steel Works, LTD.); a PCM kneader (manufactured by Ikegai); a three-roll mill, a mixing roll mill, a kneader (manufactured by INOUE MANUFACTURING Co., Ltd.); Kneadex (manufactured by NIPPON COKE & ENGINEERING, CO., LTD.); MS pressure kneader, Kneader ruder (manufactured by Moriyama Manufacturing Co., Ltd.); and a Banbury mixer (manufactured by KOBE STEEL LTD.).

Examples of the grinder include a counter jet mill, a micron jet, an ionmizer (manufactured by Hosokawa Micron Group); an IDS mill and a PJM jet grinder (manufactured by NIPPON PNEUMATIC MFG. CO., LTD.); a cross jet mill (manufactured by KURIMOTO LTD.); Urmax (manufactured by NISSO ENGINEERING CO., LTD.); SK jet 0 mill (manufactured by SEISHIN ENTERPRISE Co., Ltd.); Cryptron (manufactured by EARTHTECHNICA Co., Ltd.); a turbo mill (manufactured by FREUND-TURBE CORPORATION); and a super rotor (Nisshin Engineering Inc.).

Of them, a turbo mill is used to successfully control the average degree of circularity by adjusting the exhaust temperature during micro-grinding. If the exhaust temperature is adjusted to be low (e.g., 40° C. or less), the average degree of circularity decreases. Whereas, if the exhaust temperature is adjusted to be high (e.g., around 50° C.), the average degree of circularity increases.

Examples of the classifier include Classsiel, Micron classifier, Spedic classifier (manufactured by SEISHIN ENTERPRISE Co., Ltd.); Turbo classifier (manufactured by Nisshin Engineering Inc.); a micron separator, a turbo plex (ATP), TSP separator (manufactured by manufactured by Hosokawa Micron Group); Elbow jet (manufactured by Nittetsu Mining Co., Ltd.), a dispersion separator (manufactured by NIPPON PNEUMATIC MFG. CO., LTD.); and YM microcut (manufactured by Yasukawa Corporation).

Examples of a sieve shaker for use in sieving crude particles, etc. include Ultrasonic (manufactured by Koei Sangyo Co., Ltd.); Rezona Sieve, Gyro shifter (manufactured by TOKUJU CORPORATION); Vibrasonic system (manufactured by DALTON Co., Ltd.); Soniclean (manufactured by SINTOKOGIO, LTD.); Turbo screener (manufactured by Turbo Kogyosha); Micro shifter (manufactured by Makino mfg co., Ltd.); and a circular sieve shaker.

Examples of a mixing apparatus for externally adding a first inorganic fine particle, the aforementioned mixing apparatuses known in the art can be used; however, the apparatus shown in FIG. 4 is preferable in order to easily control coverage ratio A, B/A and the variation coefficient of coverage ratio A.

FIG. 4 is a schematic view illustrating a mixing apparatus that can be used for externally adding the first inorganic fine particle to be used in the present invention. The mixing apparatus is constituted such that shear is applied to a magnetic toner particle and a first inorganic fine particle in a narrow clearance. Because of this, it is easy to adhere the first inorganic fine particle to the surface of a magnetic toner particle. Furthermore, as described later, a magnetic toner particle and a first inorganic fine particle are easily circulated in the shaft direction of a rotating body and thus sufficiently and uniformly mixed before fixation proceeds. In these respects, the coverage ratio A, B/A, and the variation coefficient of coverage ratio A are easily controlled to fall within the preferable range of the present invention.

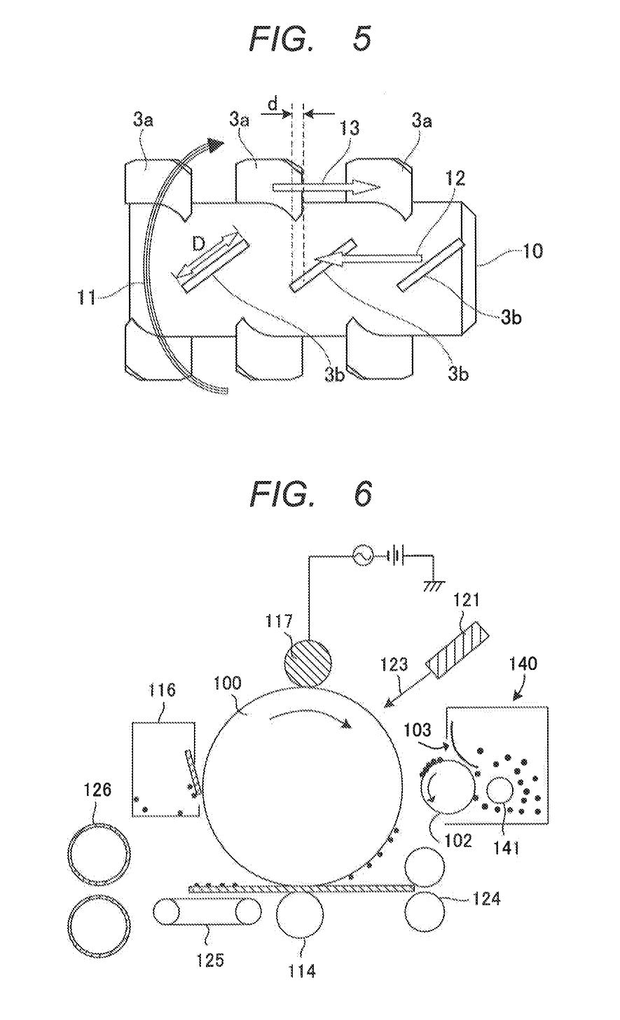

FIG. 5 is a schematic view illustrating the structure of a stirring member used in a mixing apparatus.

Now, a step of externally mixing the first inorganic fine particle as mentioned above will be described below with reference to FIG. 4 and FIG. 5.

A mixing apparatus for externally adding the inorganic fine particle as mentioned above, has a rotating body 2 having at least a plurality of stirring members 3 provided on the surface, a driving portion 8 for driving a rotating body and a main casing 1 leaving a clearance between the stirring members 3 and the casing.

It is important to keep a constant and minimum clearance between the inner peripheral portion of the main casing 1 and the stirring members 3 in order to give shear force uniformly to magnetic toner particles and easily fix the first inorganic fine particle onto the magnetic toner-particle surface.

In the apparatus, the diameter of the inner peripheral portion of the main casing 1 is twice or less as large as the diameter of the outer peripheral portion of the rotating body 2. FIG. 4 show the case where the diameter of the inner peripheral portion of the main casing is 1.7 times as large as the diameter of the outer peripheral portion of the rotating body 2 (the diameter of the body of the rotating body 2 without stirring members 3). If the diameter of the inner peripheral portion of the main casing 1 is twice or less as large as the outer peripheral portion of the rotating body 2, the treatment space where force is applied to magnetic toner particles is appropriately limited and thus impact force can be sufficiently applied to magnetic toner particles.

Furthermore, it is important to control the clearance depending upon the size of the main casing. It is important to control the clearance to fall within the range of about 1% or more and 5% or less of the diameter of the inner peripheral portion of the main casing 1 in order to apply sufficient shear force to a magnetic toner particle. More specifically, if the diameter of the inner peripheral portion of the main casing 1 is about 130 mm, the clearance may be set at about 2 to 5 mm. In contrast, if the diameter of the inner peripheral portion of the main casing 1 is about 800 mm, the clearance may be set at about 10 to 30 mm.

A step of externally adding a first inorganic fine particle of the present invention is performed by a mixing apparatus. A magnetic toner particle and the first inorganic fine particle are supplied in the mixing apparatus and stirred and mixed by rotating the rotating body 2 by the driving portion 8 to externally add the first inorganic fine particle on the surface of the magnetic toner particle.

As shown in FIG. 5, at least one of a plurality of stirring members 3 is constituted as a stirring member 3a for feeding a magnetic toner particle and an inorganic fine particle to one direction along the shaft of the rotating body according to the rotation of the rotating body 2. Furthermore, at least one of a plurality of stirring members 3 is formed as a feed-back stirring member 3b for returning the magnetic toner particle and inorganic fine particle to the other direction along the shaft of the rotating body according to the rotation of the rotating body 2.

Herein, as shown in FIG. 4, when a raw material supply port 5 and a product discharge port 6 are provided at two ends of the main casing 1, respectively, the direction from the raw material supply port 5 to the product discharge port 6 (right direction in FIG. 4) is referred to as a “feed direction”.

More specifically, as shown in FIG. 5, the plate surface of the stirring member 3a is inclined such that a magnetic toner particle is fed in the feed direction (13). In contrast, the plate surface of the stirring member 3b is inclined such that a magnetic toner particle and a first inorganic fine particle are fed in the reverse direction (12).

As described, feeding (13) in the “feed direction” and feeding (12) in the reverse direction are repeatedly performed to externally add a first inorganic fine particle to the surface of the magnetic toner particle.

Furthermore, stirring members 3a and 3b are arranged at intervals in the circumference direction of the rotating body 2. A couple is constituted of a plurality of stirring members 3a and 3b. The case shown in FIG. 5, a couple is constituted of two stirring members 3a and 3b are arranged at 180° interval on the rotating body 2; however, a couple may be constituted of a plurality of members, for example, a couple constituted of three members 3a and 3b are arranged at intervals of 120° or a couple constituted of four members 3a and 3b are arranged at intervals of 90°.

In the case shown in FIG. 5, stirring members 3a and 3b (12 members in total) are arranged at the equal intervals.

Furthermore, in FIG. 5, D represents the width of the stirring member, d represents the size of the overlapped portion between the stirring members. To efficiently feed a magnetic toner particle and a first inorganic fine particle in the feed direction and the reverse direction, width D is preferably about 20% or more and 30% of the length of the rotating body 2 shown in FIG. 5. In FIG. 5, D is 23% of the length of the rotating body 2. Furthermore, the stirring members 3a and 3b preferably have an overlapped region d of a certain size, which is shown by extension lines vertically extended from the end of the stirring member 3a. Owing to this, shear force can be effectively applied to a magnetic toner particle. The ratio d to D is preferably 10% or more and 30% or less to apply shear force.

The shape of a blade is not limited to the shape shown in FIG. 5. For example, a curved shape and a paddle structure having a blade tip portion connected via a rod-arm to the rotation body 2 may be employed as long as a magnetic toner particle can be fed in the feed direction and reverse direction and the clearance can be maintained.

Now, the present invention will be more specifically described with reference to the apparatus shown in FIG. 4 and FIG. 5.

The apparatus shown in FIG. 4 has a rotating body 2 having at least a plurality of stirring members 3 arranged on the surface, a driving portion 8 for driving the rotating body 2, a main casing 1 having a clearance between the stirring members 3 and the main casing 1, and a jacket 4 present within the main casing 1 and at side surface 10 of the rotating body and through which a cold heat medium can be circulated.

The apparatus shown in FIG. 4 has a raw material supply port 5, for introducing a magnetic toner particle and a first inorganic fine particle and formed on the upper portion of the main casing 1 and a product discharge port 6 for discharging a magnetic toner having an external additive added thereto from the main casing 1 and formed the lower portion of the main casing 1.

In the apparatus shown in FIG. 4, an inner piece 16 for the raw material supply port is inserted within the raw material supply port 5 and an inner piece 17 for the product discharge port is inserted within product discharge port 6.

In the present invention, first, the raw material supply port inner piece 16 is taken out from the raw material supply port 5, a magnetic toner particle is supplied through the raw material supply port 5 into the treatment space 9. Then, a first inorganic fine particle is supplied through the raw material supply port 5 into the treatment space 9, and then the raw material supply port inner piece 16 is inserted. Subsequently, the rotating body 2 is rotated by the driving portion 8 (reference numeral 11 represents the rotation direction) to mix the treatment materials added in the above while stirring by a plurality of stirring members 3 provided to the surface of the rotating body 2. In this manner, external additive is added.

Note that the supply order is not particularly limited. More specifically a first inorganic fine particle is supplied first from the raw material supply port 5 and then a magnetic toner particle may be supplied from the raw material supply port 5. Alternatively, a magnetic toner particle and a first inorganic fine particle are previously mixed by a mixer such as Henschel mixer, and then, the mixture may be supplied from the raw material supply port 5 of the apparatus shown in FIG. 4.

More specifically, as the conditions for the external additive mixing treatment, the power of the driving portion 8 is preferably controlled at 0.2 W/g or more and 2.0 W/g or less in order to obtain coverage ratio A, B/A, and the variation coefficient of coverage ratio A specified by the present invention. The power herein refers to a value obtained by dividing electricity required for driving stirring members for stirring raw materials by the amount of raw materials. The higher this value, the higher the shear force to be applied to the raw materials. As a result, the strength of adhesion of the external additive to a magnetic toner increases. Furthermore, the power of the driving portion 8 is more preferably controlled to be 0.6 W/g or more and 1.6 W/g or less.

If the power is lower than 0.2 W/g, coverage ratio A hardly increase and B/A tends to extremely decrease. In contrast, if the power is higher than 2.0 W/g, B/A tends to be extremely high.

The treatment time is not particularly limited; however, the treatment time is preferably 3 minutes or more and 10 minutes or less. If the treatment time is shorter than 3 minutes, B/A tends to be low and the variation coefficient of coverage ratio A tends to be high. In contrast, if the treatment time exceeds 10 minutes, B/A tends to be high and the inner temperature of the apparatus easily increases.

In the apparatus shown in FIG. 4 having a treatment space 9 of 2.0×10⁻³ m³ in volume, if the stirring members 3 have a shape shown in FIG. 5, the rotation number of the stirring members is preferably 1000 rpm or more and 3000 rpm or less. If the rotation number is 1000 rpm or more and 3000 rpm or less, the coverage ratio A, B/A, and the variation coefficient of coverage ratio A specified by the present invention can be easily obtained.

Furthermore, in the present invention, a treatment method including a premix step before an external additive mixing treatment step is particularly preferable. Since a first inorganic fine particle is highly uniformly dispersed on a magnetic toner-particle surface if the premix step is included, coverage ratio A increases and further the variation coefficient of coverage ratio A easily decreases.

More specifically, as premixing treatment conditions, the power of the driving portion 8 can be set at 0.06 W/g or more and 0.20 W/g or less and the treatment time can be set at 0.5 minutes or more and 1.5 minutes or less. If the power to be applied is lower than 0.06 W/g or the treatment time is shorter than 0.5 minutes as the premixing treatment conditions, a pre-mixture cannot be sufficiently and uniformly mixed. In contrast, if the power to be applied is higher than 0.20 W/g or the treatment time is longer than 1.5 minutes as the premixing treatment conditions, a first inorganic fine particle is often fixed onto the magnetic toner-particle surface before the mixture is sufficiently and uniformly mixed.

After completion of the external addition mixing treatment, the product discharge port inner piece 17 is taken out from the product discharge port 6 and the rotating body 2 is rotated by the driving portion 8 to discharge the magnetic toner from product discharge port 6. The obtained magnetic toner is, if necessary, sieved by e.g., a circular vibration sieve to separate rough particles. In this manner, the magnetic toner is obtained.

Furthermore, as a mixing apparatus for externally adding an organic-inorganic composite particle, the apparatus shown in FIG. 4 or a Henschel mixer (manufactured NIPPON COKE & ENGINEERING, CO., LTD.) conventionally used may be used. Furthermore, as a nixing method, an organic-inorganic composite particle may be externally added simultaneously or separately with a first inorganic fine particle.

Now, an image-forming apparatus suitably using the magnetic toner of the present invention will be described with reference to FIG. 6. In FIG. 6, reference numeral 100 represents a photosensitive drum. Members such as a charging member (charging roller) 117, a developer 140 having a toner carrier 102, a transfer member (transfer charging roller) 114, a cleaner container 116, a fixing unit 126 and a pick-up roller 124 are provided so as to surround the photosensitive drum 100. The electrostatic latent image carrier 100 is charged with the charging roller 117. When the electrostatic latent image carrier 100 is irradiated with a laser beam by a laser generator 121, an electrostatic latent image corresponding to a desired image is formed.

The electrostatic latent image formed on the electrostatic latent image carrier 100 is developed with a single component toner by the developer 140 to obtain a toner image. The toner image is transferred to a transfer material by the transfer roller 114, which is brought into contact with the electrostatic latent image carrier via a transfer material. The transfer material on which a toner image is mounted is conveyed to the fixing unit 126 and fixed onto the transfer material. The remaining magnetic tonner on the electrostatic latent image carrier is scraped off by a cleaning blade and stored in the cleaner container 116.

Now, measurement methods for physical properties of the present invention will be described below.

<Quantification Method of Organic-Inorganic Composite Fine Particle in Magnetic Toner>

In a magnetic toner obtained by externally adding a plurality of external additives to magnetic toner particles, when the content of the organic-inorganic composite fine particle is measured, external additives must be removed from the magnetic toner particle, isolated and collected.

As a specific method, for example, the following methods are mentioned.

(1) A magnetic toner (5 g) is placed in a sample bottle and methanol (200 mL) is added. If necessary, several drops of a surfactant may be added. As the surfactant, “Contaminon N” (a 10 mass % aqueous solution of a neutral detergent for washing a precision measuring apparatus, containing a nonionic surfactant, an anionic surfactant and an organic builder, pH7, manufactured by Wako Pure Chemical Industries Ltd.) can be used.
(2) The sample is dispersed by an ultrasonic cleaner for 5 minutes to separate external additives.
(3) The mixture is filtered under aspiration (10 μm membrane filter) to separate magnetic toner particles and external additives. Alternatively, a neodymium magnet is brought into contact with the bottom of the sample bottle. In this manner, while the magnetic toner particles are immobilized, the supernatant alone may be separated.
(4) The above steps (2) and (3) are repeated three times in total.

By the above operation, the external additives externally added are isolated from the magnetic toner particle. The aqueous solution recovered is centrifuged to separate a silica fine particle and an organic-inorganic composite fine particle and recover them. Subsequently, the solvent is removed and the organic-inorganic composite fine particle is sufficiently dried by a vacuum dryer and the mass of the organic-inorganic composite fine particle is measured to obtain the content.

<Quantification Method for First Inorganic Fine Particle in Magnetic Toner>

(1) Quantification of the Content of Silica Fine Particles in Magnetic Toner (Standard Addition Method)

A magnetic toner (3 g) is placed in an aluminum ring having a diameter of 30 mm and a pressure of 10 tons is applied to prepare pellets. The intensity of silicon (Si) (Si intensity-1) is obtained by wavelength dispersion X-ray fluorescence analysis (XRF). Note that any measurement conditions may be used as long as they are optimized according to the XRF apparatus to be used; however, a series of intensity measurements shall be performed all in the same conditions. To the magnetic toner, a silica fine particle having a primary-particle number average particle diameter of 12 nm (1.0 mass % relative to the magnetic toner) is added and mixed by a coffee mill.

At this time, any silica fine particles can be mixed as long as they have a primary-particle number average particle diameter within 5 nm or more and 50 nm or less, without affecting the quantification.

After mixing, the silica fine particles are pelletized in the same manner as above and the intensity of Si is obtained in the same manner as above (Si intensity-2). The same operation is repeated with respect to samples obtained by adding and mixing a silica fine particle (2.0 mass % and 3.0 mass % relative to the magnetic toner) in the magnetic toner to obtain the intensity of Si (Si intensity-3, Si intensity-4). Using Si intensity-1 to -4, the silica content (mass %) in the magnetic toner is calculated by the standard addition method. Note that if a plurality of silica particles serving as an inorganic fine particle are added, a plurality of Si intensity values are detected by XRF. Thus, in the measurement method of the invention only one type of silica particle must be used.

The titania content (mass %) and alumina content (mass %) in the magnetic toner are obtained by quantification according to the standard addition method in the same manner as in the above quantification of silica content. More specifically, the titania content (mass %) is determined by adding a titania fine particle having a primary-particle number average particle diameter of 5 nm or more and 50 nm or less, mixing them and obtaining the intensity of titanium (Ti). The alumina content (mass %) is determined by adding an alumina fine particle having a primary-particle number average particle diameter of 5 nm or more and 50 nm or less, mixing them and obtaining the intensity of aluminum (Al).

(2) Separation of Inorganic Fine Particle from Magnetic Toner Particle

A magnetic toner (5 g) is weighed in a 200 mL polycup with a cap by a precise weighing machine. To this, methanol (100 mL) is added. The mixture is dispersed by an ultrasonic disperser for 5 minutes. While the magnetic toner is attracted by a neodymium magnet, the supernatant is discarded. Operation of dispersing with methanol and discarding the supernatant is repeated three times. Thereafter, 10% NaOH (100 mL) and several drops of “Contaminon N” (a 10 mass % aqueous solution of a neutral detergent for washing a precision measuring apparatus, containing a nonionic surfactant, an anionic surfactant and an organic builder, pH7, manufactured by Wako Pure Chemical Industries Ltd.) are added and gently mixed. Thereafter, the resultant solution is allowed to stand still for 24 hours. Thereafter, the mixture is separated again by use of a neodymium magnet. At this time, it should be noted that the mixture is repeatedly rinsed with distilled water so as not to leave NaOH. The particles recovered are sufficiently dried by a vacuum dryer to obtain particle A. The silica fine particles externally added are dissolved and removed by the above operation. Since the titania fine particles and alumina fine particles are hardly dissolved in a 10% NaOH, they can remain without being dissolved. When a toner has not only a silica fine particle but also other external additives, the aqueous solution from which externally added silica fine particle is removed is centrifuged and fractionated based on the difference in specific gravity. The individual fractions are separately collected and the solvent is removed. The fractions are sufficiently dried by a vacuum dryer and subjected to measurement of mass. In this manner, the contents of inorganic particles can be obtained.

(3) Measurement of Si Intensity in particle A Particle A (3 g) is placed in an aluminum ring having a diameter of 30 mm and a pressure of 10 tons is applied to prepare pellets. The intensity of Si (Si intensity-5) is obtained wavelength dispersion X-ray fluorescence analysis (XRF). Using Si intensity-5 and Si intensity-1 to 4 used in determining the silica content in the magnetic toner to calculate the silica content (mass %) in particle A.

(4) Separation of Magnetic Member from Magnetic Toner

To particle A (5 g), tetrahydrofuran (100 mL) is added. After the solution is sufficiently mixed and then subjected to ultrasonic dispersion for 10 minutes. While the magnetic member is attracted by a magnet, the supernatant is discarded. The operation is repeated five times to obtain particle B. Organic components such as a resin other than the magnetic member can be substantially removed by the operation. However, there is a possibility for tetrahydrofuran insoluble matter to remain. Therefore, it is necessary to heat particle B obtained in the aforementioned operation up to 800° C. to burn the remaining organic components. Particle C obtained after heating can be regarded as the magnetic member contained in the magnetic toner.

The mass of particle C can be measured to obtain magnetic-substance content W (mass %) in the magnetic toner. At this time, to correct an increase by oxidation in the content of the magnetic member, the mass of particle C is multiplied by 0.9666 (Fe₂O₃→4Fe₃O₄).

In short,

Magnetic-substance content W (mass %)=((mass of particle A recovered from toner (5 g))/5)×(0.9666×(mass of particle C)/5)×100.

(5) Measurement of Ti Intensity and al Intensity in Magnetic Member Separated.

Ti and Al are sometimes contained in a magnetic member as impurities or additives. The contents of Ti and Al contained in the magnetic member can be determined by FP quantification method of wavelength dispersion XRF. The Ti amount and Al amount thus determined are expressed in terms of titania amount and alumina amount and computationally obtained as the titania and alumina content in the magnetic member.

The quantification values obtained by the above technique are assigned to the following expression to calculate the amount of externally added silica fine particles, the amount of externally added titania fine particles and the amount of externally added alumina fine particles.

Amount of externally added silica fine particles (mass %)=silica content (mass %) in magnetic toner−silica content (mass %) in particle A

Amount of externally added titania fine particles (mass %)=titania content (mass %) in magnetic toner−{titania content (mass %) in magnetic member×magnetic-substance content W (mass %)/100}

Amount of externally added alumina fine particles (mass %)=alumina content (mass %) in magnetic toner−{alumina content (mass %) in magnetic member×magnetic-substance content W (mass %)/100}

(6) Calculation of proportion of silica fine particle in metal oxide fine particle selected from the group consisting of a silica fine particle, a titania fine particle and alumina fine particle, in a first inorganic fine particle adhered to the surface of a magnetic toner particle.

In the calculation method (described later) for coverage ratio B, after an operation of “removing an unadhered first inorganic fine particle”, the toner was dried and then subjected to the same operation as in the above methods (1) to (5). In this manner, the proportion of the silica fine particle in the metal oxide fine particle can be calculated.

<Calculation of Coverage Ratio A>

In the present invention, coverage ratio A is calculated by analyzing the magnetic-toner surface image, which is photographed by a Hitachi ultrahigh resolution field-emission scanning electron microscope S-4800 (manufactured by Hitachi High-Technologies Corporation), by use of image analysis software Image-Pro Plus ver. 5.0 (Nippon Roper K.K.). The image taking conditions by S-4800 are as follows.

(1) Sample Preparation

A conductive paste is thinly applied to a sample stand (aluminum sample stand: 15 mm×6 mm) and a magnetic toner is sprayed on the conductive paste. Excessive magnetic toner is removed from the sample stand by air blow and the sample stand is sufficiently dried. The sample stand is set to a sample holder and the height of the sample stand is adjusted to a level of 36 mm by use of a sample height gauge.

(2) Setting observation conditions of S-4800 Coverage ratio A is calculated based on a reflection electron image observed under S-4800. Since the charge-up of the reflection electron image of inorganic fine particles is lower than that of a secondary electron image, coverage ratio A can be accurately measured.

In an anti-contamination trap equipped to a microscope body of S-4800, liquid nitrogen is injected until it spills over and allowed to stand still for 30 minutes. “PC-SEM” of S-4800 is started up and an FE tip (electronic source) is flashed and cleaned. In the window, acceleration voltage displayed on the control panel is clicked and the [Flashing] button is pressed to open a flash-execution dialog. After the intensity level of flashing is confirmed to be 2 and executed. Then, the emission current by flashing is confirmed to be 20 to 40 μA. A sample holder is inserted into a sample chamber of the 5-4800 microscope body. A button [HOME] on the control panel is pressed to move the sample holder to a viewing position.

The “acceleration voltage” display is clicked to open the HV setting dialog. The acceleration voltage is set at [0.8 kV] and the emission current is set at [20 μA]. In the [SEM] tab of the operation panel, the signal section is set at [SE] and the SE detector is set at [Upper (U)] and [+BSE] is selected. In the selection box at the right side of [+BSE], [L.A.100] is selected to set a mode of observing a reflection electron image. In the same [SEM] tab on the operation panel, the probe current in the block of electronic optical condition is set at [Normal], the focal mode at [UHR] and WD at [3.0 mm]. In the acceleration voltage display on the control panel, button [ON] is pressed to apply the acceleration voltage.

(3) Calculation of Number-Average Particle Diameter (D1) of Magnetic Toner

In the “magnification” display on the control panel, magnification is set at 5000 (5 k) fold by dragging the mouse. On the operation panel, the focus knob [COARSE] is turned to roughly bring a focus on a sample and then aperture alignment is adjusted. On the control panel, [Align] is clicked to display the alignment dialog and then, [Beam] is selected. STIGMA/ALIGNMENT knobs (X, Y) on the operation panel are turned to move the beam displayed there to the center of concentric circles. Next, [Aperture] is selected and STIGMA/ALIGNMENT knobs (X, Y) are turned one by one to stop or minimize the movement of an image. The aperture dialog is closed and a focus is automatically brought on the sample. This operation is repeated further twice to bring a focus on the sample.

Thereafter, the diameters of 300 magnetic toner particles are measured to obtain a number-average particle diameter (D1). Note that the particle diameter of each magnetic toner particle is specified as the maximum diameter of the magnetic toner particle observed.

(4) Focusing

The particle obtained in (3) and having a number-average particle diameter (D1) of ±0.1 μm is placed such that the middle point of the maximum diameter is aligned with the center of the measurement screen. In this state, a mouse is dragged in the magnification display of the control panel to set magnification at 10000 (10 k) fold. Then, a focus knob [COARSE] on the operation panel is turned to roughly bring a focus on the sample. Then, aperture alignment is adjusted. On the control panel, [Align] is clicked to display the alignment dialog. Then, [beam] is selected. On the operation panel, when STIGMA/ALIGNMENT knobs (X, Y) are turned to move the beam displayed there to the center of concentric circles. Next, [Aperture] is selected and STIGMA/ALIGNMENT knobs (X, Y) are turned one by one to stop or minimize the movement of an image. The aperture dialog is closed and automatically bring a focus on the image. Thereafter, magnification is set at 50000 (50 k) fold, a focus is brought on the image by using the focus knob and STIGMA/ALIGNMENT knob in the same manner as above and a focus is again automatically brought on the sample. This operation is repeated again to bring a focus on the sample. Herein, if the inclination angle of an observation surface is large, measurement accuracy for obtaining coverage ratio is likely to decrease. Accordingly, in focusing, a sample whose surface has a low inclination angle is selected by selecting a sample on the entire surface of which comes into focus at the same time and used for analysis.

(5) Image Storage

Brightness is controlled in an ABC mode and an image having a size of 640×480 pixels is taken and stored. This image file is subjected to the following analysis. A single picture is taken per magnetic toner particle and images of at least 30 magnetic toner particles are obtained.

(6) Image Analysis

In the present invention, the images obtained by the technique described above are subjected to binarization using the following analysis software to calculate coverage ratio A. In analysis, the picture plane obtained above is split into 12 squares and individual squares are analyzed. However, if a first inorganic fine particle having a particle diameter of 50 nm or more is seen in a sprit square section, calculation of coverage ratio A shall not be performed in this section.

The analysis conditions for image analysis software Image-Pro Plus ver. 5.0 are as follows:

Software Image-Pro Plus 5.1J

The “Measure” of the toolbar is opened and then “Count/Size” and then “Options” are selected to set binarization conditions. In the object extraction options, 8-Connect is checked and Smoothing is set at 0. Others, i.e., “Pre-Filter”, “Fill Holes”, “Convex Hull” are unchecked, and “Clean Borders” is set at “None”. In “Measure” of the toolbar, “Select Measurements” are selected and 2 to 10⁷ is input in Filter Ranges of Area.

Coverage ratio is calculated by encircling a square region. The area (C) of the region is set so as to have 24000 to 26000 pixels. Then, “Process”-binarization is selected to perform automatic binarization. The total area (D) of the regions in which silica is not present is calculated.

Based on the area C of a square region, the total area D of the regions in which silica is not present, coverage ratio a is obtained according to the following expression:

Coverage ratio a(%)=100−(D/C×100)

As described above, coverage ratio a is calculated with respect to 30 magnetic toner particles or more. An average value of all data obtained is regarded as coverage ratio A in the present invention.

<Variation Coefficient of Coverage Ratio A>

In the present invention, the variation coefficient of coverage ratio A is obtained as follows. Provided that the standard deviation of all coverage ratio data used in the aforementioned coverage ratio A calculation is represented by σ(A), the variation coefficient of coverage ratio A can be obtained according to the following expression:

Variation coefficient (%)={σ(A)/A}×100

<Calculation of Coverage Ratio B>

Coverage ratio B is calculated by first removing unadhered first inorganic fine particle on a magnetic-toner surface and then repeating the same operation as in calculation of coverage ratio A.

(1) Removal of Unadhered First Inorganic Fine Particle

Unadhered first inorganic fine particles are removed as follows. In order to sufficiently remove particles except inorganic fine particle embedded in the surface of toner particles, the present inventors studied and determined the removal conditions.

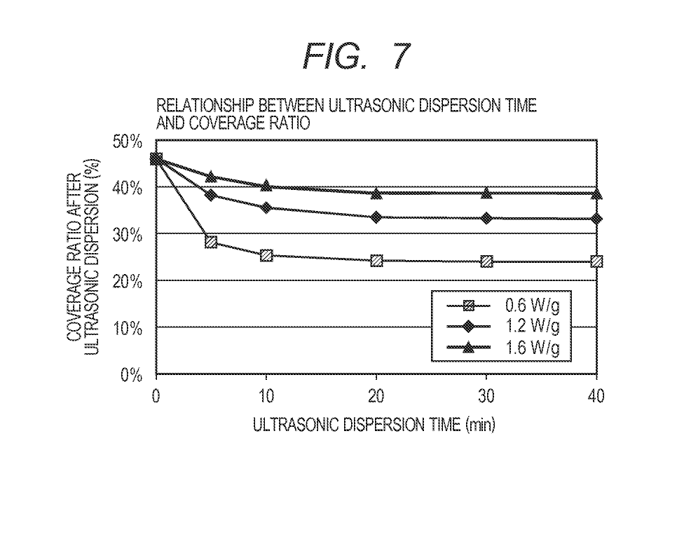

As an example, magnetic toners are prepared by adding external additives at three strengths of power so as to obtain coverage ratio A of 46% by using the apparatus shown in FIG. 4. The magnetic toner is ultrasonically dispersed. The relationship between ultrasonic dispersion time and coverage ratio computationally obtained after the ultrasonic dispersion is shown in FIG. 7. FIG. 7 was prepared as follows. After an inorganic fine particle was removed by ultrasonic dispersion according to the following method, the magnetic toner was dried. The coverage ratio of the magnetic toner was obtained in the same manner as in the above coverage ratio A.

From FIG. 7, it is found that the coverage ratio reduces with the removal of an inorganic fine particle by ultrasonic dispersion, and that the coverage ratio reaches a plateau on and after ultrasonic dispersion time of 20 minutes at any power applied during external addition operation. From this, it is determined that ultrasonic dispersion of 30 minutes is sufficient to remove an inorganic fine particles except the inorganic fine particles embedded in the surface of a toner particle. The coverage ratio obtained at this time was defined as coverage ratio B.

More specifically, water (16.0 g) and Contaminon N (neutral detergent, Product No. 037-10361, manufactured by Wako Pure Chemical Industries Ltd.) (4.0 g) are placed in a 30 mL glass vial and sufficiently mixed. To the solution thus prepared, a magnetic toner (1.50 g) is added and allowed to totally precipitate by applying a magnet close to the bottom surface. Thereafter, air bubbles are removed by moving the magnet; at the same time, the magnetic toner is allowed to settle in the solution.

An ultrasonic vibrator UH-50 (titanium alloy tip having a tip diameter of φ6 mm is used, manufactured by SMT Co., Ltd.) is set such that the tip comes to the center of the vial and at a height of 5 mm from the bottom surface of the vial. Inorganic fine particles are removed by ultrasonic dispersion. After ultrasonic wave is applied for 30 minutes, the whole amount of magnetic toner is taken out and dried. At this time, application of heat is avoided as much as possible. Vacuum dry is performed at 30° C. or less.

(2) Calculation of Coverage Ratio B

Coverage ratio of the magnetic toner after dried is calculated in the same manner as in coverage ratio A as mentioned above to obtain coverage ratio B.

<Method for Determining Primary-Particle Number Average Particle Diameter of First Inorganic Fine Particle>

The primary-particle number average particle diameter of a first inorganic fine particle can be calculated based on the image of first inorganic fine particles on a magnetic-toner surface photographed by a Hitachi ultrahigh resolution field-emission scanning electron microscope 5-4800 (manufactured by Hitachi High-Technologies Corporation). The image-taking conditions by S-4800 are as follows.

Operations of the methods (1) to (3) are performed in the same manner as in the “Calculation of coverage ratio A”. Similarly to (4), a camera is brought into focus on a magnetic-toner surface at 50000 (50 k) fold magnification and brightness is adjusted in an ABC mode. Thereafter, magnification is changed to 100000 (100 k) fold and then focus is brought into the magnetic-toner in the same manner as in (4) by use of a focus knob and a STIGMA/ALIGNMENT knob and then an autofocus system is used to bring focus. The focusing operation is repeated again at 100000 (100 k) fold magnification.

Thereafter, particle diameters of at least 300 inorganic fine particles a on the magnetic-toner surface are measured to obtain a number-average particle diameter (D1). Since inorganic fine particles a are sometimes present as aggregates herein, the maximum diameters of particles which can confirmed as primary particles are measured and the obtained maximum diameters are arithmetically averaged to obtain the primary-particle number average particle diameter (D1).

<Weight Average Particle Diameter (D4) of Magnetic Toner and Grain Size Distribution Measurement Method>

The weight average particle diameter (D4) of a magnetic toner is calculated as follows. As a measurement apparatus, a precise grain size distribution measurement apparatus “Coulter•counter Multisizer 3” (registered trade mark, manufactured by Beckman Coulter, Inc.) equipped with a 100 μm-aperture tube and based on the pore electrical resistance method. The accompanying dedicated software “Beckman Coulter Multisizer 3 Version 3.51” (manufactured by Beckman Coulter, Inc.) is used for setting measurement conditions and analysis of measurement data. Note that, effective measurement channels; i.e., 25000 channels are used for measurement.

An aqueous electrolyte for use in measurement is prepared by dissolving special-grade sodium chloride in ion exchange water in a concentration of about 1 mass %. For example, “ISOTON II” (manufactured by Beckman Coulter, Inc.) can be used.

Note that, before measurement and analysis, the dedicated software is set as follows.

In the window “Changing Standard Operating Method (SOM)” of the dedicated software, the total count number in the control mode is set at 50000 particles; “measurement times” is set at 1; and a value obtained by using “Standard Particles 10.0 μm” (manufactured by Beckman Coulter, Inc.) is set at as a Kd value. The “Threshold/Measure Noise Level button” is pressed to automatically set threshold and noise level. Furthermore, the current is set at 1600 μA; the gain is set at 2, the electrolytic solution is set at ISOTON II; and the “Flush Aperture Tube after each run” box is checked.

In the window “Convert Pulses to Size” of the dedicated software, the bin interval is set at logarithmic particle diameter; the particle diameter bin is set at 256 particle diameter bin; and the particle diameter range is set at 2 μm to 60 μm.

The measurement method is more specifically as follows:

(1) To a 250-mL round-bottom glass beaker for exclusive use for Multisizer 3, the aqueous electrolyte (about 200 mL) is added. The beaker is set in a sample stand, stirred counterclockwise with a stirrer rod at a rate of 24 rotations/second. The smudge and air bubbles of an aperture tube are removed in advance by the “Flush Aperture” function of the dedicated software.
(2) To a 100 mL flat-bottom glass beaker, the aqueous electrolyte about (30 mL) is added. To the beaker, a diluted solution (about 0.3 mL) of “Contaminon N” (a 10 mass % aqueous solution of a neutral detergent for washing a precision measuring apparatus, containing a nonionic surfactant, an anionic surfactant and an organic builder, pH7, manufactured by Wako Pure Chemical Industries Ltd.) prepared by diluting with ion exchange water to about three mass fold, is added.
(3) An ultrasonic disperser “Ultrasonic Dispersion System Tetora 150” (manufactured by Nikkaki Bios Co., Ltd) having an electric power of 120 W with two oscillators having an oscillatory frequency of 50 kHz installed therein so as to have a phase difference of 180°, is prepared. About 3.3 L of ion exchange water is added to the water vessel of the ultrasonic disperser, and Contaminon N (about 2 mL) is added to the water vessel.
(4) The beaker (2) is set in a beaker-immobilization hole of the ultrasonic disperser, and then the ultrasonic disperser is driven. Then, the height of the beaker is adjusted such that the resonant state of the liquid surface of the aqueous electrolyte in the beaker reaches a maximum.
(5) While the aqueous electrolyte in the beaker (4) is irradiated with ultrasonic wave, a toner (about 10 mg) is added to the aqueous electrolyte little by little and dispersed. The dispersion treatment with ultrasonic wave is further continued for 60 seconds. Note that in the ultrasonic dispersion, the temperature of water in the water vessel is appropriately adjusted so as to fall within the range of 10° C. or more and 40° C. or less.
(6) To the round-bottom beaker (1) set in the sample stand, the aqueous electrolyte (5) in which the toner is dispersed is added dropwise by use of a pipette. In this manner, the measurement concentration is adjusted to be about 5%. Measurement is performed until the number of measured particles reaches 50000.
(7) Measurement data is analyzed by dedicated software attached to the apparatus to calculate a weight average particle diameter (D4). Note that when graph/volume % is set in the dedicated software, “average diameter” displayed in the window “Analyze/Volume Statistics (Arithmetic)” is the weight average particle diameter (D4).

### <Method for Determining Average Circularity of Magnetic Toner>

The average circularity of a magnetic toner is determined by a flow-system particle image measurement apparatus “FPIA-3000” (manufactured by SYSMEX CORPORATION) in the same measurement and analysis conditions as in a calibration operation.

The determination method is more specifically as follows. First, in a glass container, ion exchange water (about 20 mL), from which impure substances are previously removed, is placed. To the glass container, about 0.2 mL of a solution of “Contaminon N” (a 10 mass % aqueous solution of a neutral detergent for washing a precision measuring apparatus, containing a nonionic surfactant, an anionic surfactant and an organic builder, pH7, manufactured by Wako Pure Chemical Industries Ltd.) diluted with ion exchange water up to about 3 times by mass, was added, and further a measurement sample (about 0.02 g) was added and dispersed for two minutes by an ultrasonic disperser to obtain a dispersion solution for measurement. At this time, the dispersion solution is appropriately cooled such that the temperature of the dispersion solution becomes 10° C. or more and 40° C. or less. As the ultrasonic disperser, a desktop ultrasonic cleaner (disperser) (for example “VS-150” (manufactured by VELVO-CLEAR)) having an oscillation frequency of 50 kHz and an electrical output of 150 W is used. In a water vessel, a predetermined amount of ion exchange water is placed and the Contaminon N (about 2 mL) is added to the water vessel.

In measurement, a flow-system particle image measurement apparatus having a regular objective lens (magnification: 10×) installed therein is used and particle sheath “PSE-900A” (manufactured by SYSMEX CORPORATION) is used as a sheath fluid. The dispersion solution is prepared according to the aforementioned procedure and introduced in the flow-system particle image measurement apparatus. Magnetic toner particles (3000 particles) are measured in an HPF measurement mode and a total count mode. Then, the average circularity of the magnetic toner is obtained by setting the binarization threshold during particle analysis at 85% and limiting the diameter of particles to be analyzed to a circle-equivalent diameter of 1.985 μm or more and less than 39.69 μm.

Before initiation of measurement, autofocusing is performed by using a standard latex particle (for example, “RESEARCH AND TEST PARTICLE Latex Microsphere Suspensions 5200A” manufactured by Duke Scientific diluted with ion exchange water). Thereafter, every two hours after initiation of measurement, focusing is preferably performed.

Note that in the present invention, a flow-system particle image measurement apparatus having a calibration certificate, which proves that calibration operation was performed by SYSMEX CORPORATION) is used. Measurement is performed under the same measurement and analysis conditions as employed in the calibration certificate are used except that the diameter of particles to be analyzed is limited to a circle-equivalent diameter of 1.985 μm or more and less than 39.69 μm.

Measurement by the flow-system particle image measurement apparatus “FPIA-3000” (manufactured by SYSMEX CORPORATION) is basically performed by taking a photograph of a flowing particle as a static image, and analyzing the static image. The sample fed to a sample chamber is taken by a sample suction syringe and fed to a flat sheath flow cell. The sample fed to the flat sheath flow forms a flat flow sandwiched by sheath fluid. The sample passing through the flat sheath flow cell is irradiated by stroboscopic light at intervals of 1/60 seconds to enable a flowing particle to be taken as a static image. Since the flow is flat, focused images are obtained. The image of a particle is taken by a CCD camera and the taken image is processed at an image processing resolution of 512×512 pixels (0.37 μm×0.37 μm per pixel) and projected area S and perimeter L of a particle image are determined by extracting the contour of each particle image.

Next, a circle-equivalent diameter and a degree of circularity are obtained by using area S and perimeter L obtained above. The circle-equivalent diameter refers to the diameter of a circle having the same area as the projected area of a particle image. The degree of circularity is defined as a value obtained by dividing the perimeter of the circle obtained based on a circle-equivalent diameter by the perimeter of the particle projection image and calculated according to the following expression:

Degree of circularity=2×(η×S)^{1/2}/L

When a particle image is circular, the degree of circularity is 1.000. As the degree of unevenness of a peripheral particle image increases, the degree of circularity decreases. After the degree of circularity of each particle is calculated, the range of degree of circularity from 0.200 to 1.000 is divided into 800 portions and arithmetic mean value of the obtained degrees of circularity is computationally obtained and specified as the average circularity.

<Method for Measuring Acid Values of Magnetic Toner and Resin>

In the present invention, an acid value is obtained by the following operation based on JIS K0070.

As a measurement apparatus, a potentiometric titration measurement apparatus is used. Titration can be automatically performed by use of a potentiometric titration measurement apparatus AT-400 (winworkstation) and APB-410 electric burette of KYOTO ELECTRONICS MANUFACTURING CO., LTD.

In calibration of the apparatus, a solvent mixture of toluene (120 mL) and ethanol (30 mL) is used. The measurement temperature is set at 25° C.

A sample is prepared by adding a magnetic toner (1.0 g) or a resin (0.5 g) in the solvent mixture of toluene (120 mL) and ethanol (30 mL) and ultrasonically dispersing the sample solution for 10 minutes. Thereafter, a magnetic stirrer is placed and a lid is provided, and then, the sample solution is stirred for about 10 hours to dissolve the toner or resin. A blank test is performed by using a 0.1 mol/L ethanol solution of potassium hydroxide. The use amount of ethanol solution of potassium hydroxide is specified as B (mL). The magnetic member in the sample solution obtained after stirring for 10 hours is separated by magnetic force and the soluble matter (of the sample solution containing a magnetic toner or a resin) is titrated. The use amount of potassium hydroxide solution is specified as S (mL).

The acid value is calculated according to the following expression. Note that, in the following formula, f represents a KOH factor and W represents the mass of a sample.

Acid value (mg KOH/g)={(S−B)×f×5.61}/W

<Method for Measuring Peak Molecular Weight of Resin>

The peak molecular weight of a resin is measured by gel permeation chromatography (GPC) in the following conditions.

A column is stabilized in a heat chamber at 40° C. To the column kept at the same temperature, tetrahydrofuran (THF) serving as a solvent is supplied at a rate of 1 ml per minute. As the column, a plurality of commercially available polystyrene gel columns are used in combination, in order to accurately measure a molecular weight within the range of 1×10³ to 2×10⁶. For example, Shodex GPC KF-801, 802, 803, 804, 805, 806, 807 and 800P manufactured by SHOWA DENKO K. K. are used in combination. Alternatively, TSK gel G1000H (H_{XL}), G2000H (H_{XL}), G3000H (H_{XL}), G4000H (H_{XL}), G5000H (H_{XL}), G6000H (H_{XL}), G7000H (H_{XL}) and TSK guard column manufactured by Tohso Corporation are used in combination. Of them, particularly 7-connected Shodex KF-801, 802, 803, 804, 805, 806, 807 manufactured by SHOWA DENKO K. K. is preferable.

On the other hand, a resin is dispersed and dissolved in THF, allowed to stand still overnight and filtered by a sample treatment filter (pore size 0.2 to 0.5 μm, for example, Myshori Disk H-25-2 (manufactured by Tohso Corporation) can be used). The filtrate is used as a sample. The concentration of the sample is controlled such that a resin component is contained in an amount of 0.5 to 5 mg/mL in a THF solution. Measurement is performed by injecting the THF solution of the resin thus obtained in an amount of 50 to 200 μL. Note that, as a detector, an RI (refractive index) detector is used.

In measuring the molecular weight of a sample, the molecular weight distribution of the sample is calculated based on the relationship between a logarithmic value of a calibration curve, which was prepared using several mono-dispersion polystyrene standard samples, and count number. As the standard polystyrene samples for preparing the calibration curve, standard polystyrene samples having a molecular weight of 6×10², 2.1×10³, 4×10³, 1.75×10⁴, 5.1×10⁴, 1.1×10⁵, 3.9×10⁵, 8.6×10⁵, 2×10⁶ and 4.48×10⁶ manufactured by Pressure Chemical Co. or Tohso Corporation are used. It is proper to use at least about 10 standard polystyrene samples.

<Measurement Method for Number-Average Particle Diameter of External Additive>

The number-average particle diameter of an external additive is measured by a scanning electron microscope “S-4800” (trade name; manufactured by Hitachi, Ltd.). A toner to which the external additive is externally added is observed at a magnification of at most 200,000 fold, and major axes of 100 primary particles of the external additive are measured to obtain the number-average particle diameter. The observation magnification is appropriately adjusted depending upon the particle size of the external additive.

<Method for Measuring Volumetric Specific Heat>

In the present invention, volumetric specific heat was obtained by separately obtaining a specific heat value (kJ/kg·° C.) and a true density value (kg/m³) of a sample and multiplying both values.

The specific heat was measured by an input compensation type differential scanning calory measurement apparatus DSC8500 manufactured by TA Instruments in StepScan mode. An aluminum pan was used for a sample and a vacant pan was used for a control. The sample was allowed to stand at 20° C. for one minute while keeping the temperature and then increased up to 100° C. at a rate of 10° C./min. The specific heat at 80° C. was computationally obtained.

The true density was determined by a dry-type automatic densimeter AccuPyc 1330 manufactured by Shimadzu Corporation.

When the volumetric specific heat values of a toner core and organic-inorganic composite particle are measured as follows. For example, the core and organic-inorganic composite particle are separated by placing the toner in ion exchange water to which several drops of “Contaminon N” (a 10 mass % aqueous solution of a neutral detergent for washing a precision measuring apparatus, containing a nonionic surfactant, an anionic surfactant and an organic builder, pH7, manufactured by Wako Pure Chemical Industries Ltd.) are added dropwise, ultrasonically dispersing the toner and allowing it to stand still for 24 hours. The supernatant is collected and dried. In this manner, an external additive can be isolated. If a plurality of external additives are added to a toner, they can be isolated by centrifugally separating the supernatant.

### EXAMPLES

The present invention will be more specifically described below by way of Examples and Comparative Examples; however, the present invention is not limited to these. Note that “parts” described in Examples and Comparative Examples refers to parts by mass, unless otherwise specified.

### Production Example of Binder Resin

### Production Example of Binder Resin

The mole ratio of a polyester monomer is as follows.

BPA-PO/BPA-EO/TPA/TMA/FA=50/50/70/15/10

where,
BPA-PO: bisphenol A propylene oxide, 2.2 mole adduct
BPA-EO: bisphenol A ethylene oxide, 2.2 mole adduct
TPA: terephthalic acid
TMA: trimellitic anhydride
FA: fumaric acid

Of the raw material monomers shown above, the raw material monomers except TMA and tetrabutyl titanate (0.1 mass %) serving as a catalyst were added to a flask equipped with a dewatering conduit, a stirring blade and a nitrogen introduction pipe. The monomers in the flask were condensation-polymerized at 210° C. for 11 hours. To the reaction solution, TMA was added and reacted at 200° C. until an acid value reached a desired value to obtain polyester resin 1 (glass transition point Tg: 63° C., acid value: 17 mgKOH/g, peak molecular weight: 6200).

### Production Example of Crystalline Resin

| | |
|---|---|
| 1,6-Hexane diol | 100.0 parts by mol |
| Fumaric acid | 100.0 parts by mol |

0.2 mass % dibutyltin oxide 1.0 mass % relative to the total amount of raw material and monomers was placed in a 10 L four-neck flask equipped with a nitrogen introduction pipe, a dewatering conduit, a stirring device and a thermocouple, and reacted at 180° C. for 4 hours, raised in temperature at a rate of 10° C./one hour up to 210° C., maintained at 210° C. for hours, reacted at 8.3 kPa for one hour to obtain a crystalline resin. The melting point of the resin was 71° C.

### Production Example 1 of Magnetic Toner Particle

| | | |
|---|---|---|
| Binder resin 1: | 100.0 | parts |
| Wax: | 5.0 | parts |
| (low molecular-weight polyethylene, melting point: 94° C., | | |
| number average molecular weight Mn: 800) | | |
| Magnetic member: | 95.0 | parts |
| (composition: Fe₃O₄, shape: spherical, primary-particle | | |
| number average particle diameter: 0.21 μm, magnetic | | |
| properties at 795.8 kA/m; Hc: 5.5 kA/m, σs: 84.0 Am²/kg, | | |
| σr: 6.4 Am²/kg) | | |
| Charge control agent T-77: | 1.0 | part |
| (manufactured by Hodogaya Chemical Co., LTD) | | |

The raw materials were preparatorily mixed by a Henschel mixer, FM10C (Mitsui Miike Koki), and kneaded by a twin screw kneading extruder (PCM-30: manufactured by Ikegai Tekkosho) at a rotation number of 200 rpm while adjusting the temperature such that the direct temperature of a kneaded product near the outlet became 155° C.

The obtained melt-kneaded product was cooled and roughly ground by a cutter mill. Thereafter, the rough ground product obtained above was finely ground by a turbo mill T-250 (manufactured by TURBO-CORPORATION) in a feed amount of 20 kg/hr while controlling air temperature so as to obtain an exhaust temperature of 38° C. The obtained fine ground product was classified by a multi classifier using the Coanda effect to obtain magnetic toner particle 1 having a weight average particle diameter (D4) of 7.9 μm.

### Production Example 2 of Magnetic Toner Particle

| | | |
|---|---|---|
| Binder resin 1: | 100.0 | parts |
| Wax: | 3.0 | parts |
| (low-molecular weight polyethylene, melting point: 94° C., | | |
| number average molecular weight Mn: 800) | | |
| Crystalline resin obtained above | 10.0 | parts |
| Magnetic member | 95.0 | parts |
| (composition: Fe₃O₄, shape: spherical, primary-particle | | |
| number average particle diameter: 0.21 μm, magnetic | | |
| properties at 795.8 kA/m; Hc: 5.5 kA/m, σs: 84.0 Am²/kg, | | |
| σr: 6.4 Am²/kg) | | |
| Charge controlling agent (T-77, Hodogaya Chemical Co., | 1.0 | part |
| LTD): | | |

The raw materials shown above were preparatorily mixed by Henschel mixer FM10C (MitsuiMiike Kakoki Kabushiki Kaisha) and kneaded by a twin screw kneading extruder (PCM-30: manufactured by Ikegai Tekkosho) at a rotation number of 200 rpm while adjusting the temperature such that the direct temperature of a kneaded product near the outlet became 155° C.

The melt-kneaded product obtained was cooled and roughly ground by a cutter mill. The ground product obtained was finely ground by a turbo mill T-250 (manufactured by Turbo Kogyou) in a feed amount of 20 kg/hr while adjusting air temperature so as to obtain an exhaust temperature of 38° C. and classified by a multifraction classifier using the Coanda effect to obtain magnetic toner particle 2 having a weight average particle diameter (D4) of 8.1 μm.

<Organic-Inorganic Composite Particles 1 to 5>

Organic-inorganic composite particles can be produced, for example, according to the description of Examples of International Publication No. WO 2013/063291.

The organic-inorganic composite particles to be used in the following Examples were produced by using silica shown in Table 1 according to Example 1 of International Publication No. WO 2013/063291. The physical properties of organic-inorganic composite particles 1 to 5 are shown in Table 1. Note that organic-inorganic composite particles 1 to 5 were each constituted of an inorganic fine particle embedded in a resin particle.

TABLE 1
Physical properties of organic-inorganic composite particle

| | | Particle | | Number average | |
|---|---|---|---|---|---|
| | | diameter of | Content of | particle diameter of | |
| | | colloidal | inorganic fine | organic-inorganic | Volumetric |
| | | silica | particle | composite particle | specific heat |
| | Type | [nm] | [mass %] | [nm] | (kJ/m³ · ° C.) |
| Organic-inorganic | Colloidal | 25 | 56% | 113 | 3292 |
| composite particle 1 | silica | | | | |
| Organic-inorganic | Colloidal | 25 | 49% | 143 | 3390 |
| composite particle 2 | silica | | | | |
| Organic-inorganic | Colloidal | 15 | 64% | 62 | 3596 |
| composite particle 3 | silica | | | | |
| Organic-inorganic | Colloidal | 25 | 67% | 106 | 4151 |
| composite particle 4 | silica | | | | |
| Organic-inorganic | Colloidal | 15 | 46% | 99 | 2967 |
| composite particle 5 | silica | | | | |

<Other Additives>

As the additives used, except the above organic-inorganic composite particle, in Production Examples of toner described later, an organic particle of Epostar series manufactured by NIPPON SHOKUBAI CO., LTD., and an inorganic particle of Seahostar series manufactured by NIPPON SHOKUBAI CO., LTD. were used.

### Production Example 1 of Silica Fine Particle

Silica fine particle 1 was obtained by treating silica (100 parts) having a BET specific surface area of 130 m²/g and a primary-particle number average particle diameter (D1) of 12 nm, with hexamethyldisilazane (10 parts) and then with dimethylsilicone oil (10 parts).

### Production Example 2 of Silica Fine Particle

Silica fine particle 2 was obtained by treating silica (100 parts) having a BET specific surface area of 200 m²/g and a primary-particle number average particle diameter (D1) of 8 nm, with hexamethyldisilazane (10 parts) and then with dimethylsilicone oil (10 parts).

### Production Example 3 of Silica Fine Particle

Silica fine particle 3 was obtained by treating silica (100 parts) having a BET specific surface area of 90 m²/g and a primary-particle number average particle diameter (D1) of 26 nm with hexamethyldisilazane (10 parts) and then with dimethylsilicone oil (10 parts).

### Production Example 4 of Silica Fine Particle

Silica fine particle 4 was obtained by treating silica (100 parts) having a BET specific surface area of 50 m²/g and a primary-particle number average particle diameter (D1) of 43 nm with hexamethyldisilazane (10 parts) and then with dimethylsilicone oil (10 parts).

### Production Example of Alumina Fine Particle

An alumina fine particle was obtained by treating alumina fine particle (100 parts) having a BET specific surface area 120 m²/g and a primary-particle number average particle diameter (D1) of 15 nm with isobutyltrimethoxysilane (10 parts).

### Production Example of Titania Fine Particle

A titania fine particle was obtained by treating titania fine particle (100 parts) having a BET specific surface area 115 m²/g and a primary-particle number average particle diameter (D1) of 15 nm with isobutyltrimethoxysilane (10 parts).

### Production Example 1 of Magnetic Toner

To magnetic toner particle 1 obtained in Production Example 1 of magnetic toner particle, external additives was added by using the apparatus shown in FIG. 4.

In this Example, the apparatus shown in FIG. 4 (the inner periphery diameter of main-body casing 1: 130 mm, the volume of a treatment space 9: 2.0×10⁻³ m³) was used. The rated power of a driving portion 8 was set at 5.5 kW. The shape of a stirring member 3 as shown in FIG. 5 was used. In FIG. 5, the width d of overlapped portion of a stirring member 3a with a stirring member 3b was set at 0.25D where D represents a maximum width of the stirring member 3, and the clearance between the stirring member 3 and the inner circumference of the main body casing 1 was set at 3.0 mm.

Magnetic toner particle 1 (100 parts (500 g)) and an external additive in the addition amount shown in Table 2 were supplied to the apparatus shown in FIG. 4 having the aforementioned constitutions.

After supplied, the magnetic toner particle and the external additive were premixed in order to uniformly mix them. The conditions for premix are as follows: power for driving portion 8: 0.1 W/g (rotation number of a driving portion 8: 150 rpm); and treatment time: 1 minute.

After completion of the premix, external additives were mixed. As conditions for an external additive mixing treatment, the circumferential speed of the outmost part of the stirring member 3 was adjusted so as to provide a constant power (the driving portion 8) of 1.0 W/g (rotation number of the driving portion 8: 1800 rpm), and a treatment was performed for 5 minutes. The conditions for the external additive mixing treatment are shown in Table 2.

After the external additive mixing treatment, rough particles and others were removed by a circular vibration sieve provided with a screen having a diameter of 500 mm and a sieve opening of 75 μm to obtain magnetic toner 1. Magnetic toner 1 was observed by a scanning electron microscope. Using a magnified view of magnetic toner 1, the primary-particle number average particle diameter of silica fine particles on the magnetic-toner surface was determined, it was 14 nm. The external addition conditions of magnetic toner 1 are shown in Table 2 respectively.

### Production Examples 2 to 27 of Magnetic Toner

Magnetic toners 2 to 27 were prepared in the same manner as in Magnetic toner 1 except the conditions shown in Table 2.

TABLE 2
Production Example of toner

| | | Formula of External additive | | | | | | | | | | |
|---|---|---|---|---|---|---|---|---|---|---|---|---|
| | | | Addition | | | | | | | | | |
| | | | amount of | Content of | | | | | | | | |
| | | | large-particle | large-particle | | Addition | | | Addition | | | |
| | | Type of | external | external | Type of first | amount of first | Content of first | Type of first | amount of first | Content of first | | External |
| | Toner particle | large-particle | additive | additive | inorganic fine | inorganic fine | inorganic fine | inorganic fine | inorganic fine | inorganic fine | External addition | addition |
| | Type | external additive | (parts) | (parts) | particle | particle (parts) | particle (parts) | particle | particle (parts) | particle (parts) | apparatus | condition |
| Magnetic | Magnetic toner | Organic-inorganic | 2.0 | 1.9 | Silica fine | 2 | 1.74 | — | — | — | Apparatus shown | Pre-mixture |
| toner 1 | particle 1 | composite particle 1 | | | particle 1 | | | | | | in FIG. 4 | 1 W/g * 5 min |
| Magnetic | Magnetic toner | Organic-inorganic | 1.0 | 1.0 | Silica fine | 2 | 1.68 | — | — | — | Apparatus shown | Pre-mixture |
| toner 2 | particle 1 | composite particle 1 | | | particle 1 | | | | | | in FIG. 4 | 1 W/g * 5 min |
| Magnetic | Magnetic toner | Organic-inorganic | 0.7 | 0.7 | Silica fine | 2 | 1.68 | — | — | — | Apparatus shown | Pre-mixture |
| toner 3 | particle 1 | composite particle 1 | | | particle 1 | | | | | | in FIG. 4 | 1 W/g * 5 min |
| Magnetic | Magnetic toner | Organic-inorganic | 2.5 | 2.4 | Silica fine | 2.3 | 1.932 | — | — | — | Apparatus shown | Pre-mixture |
| toner 4 | particle 1 | composite particle 1 | | | particle 1 | | | | | | in FIG. 4 | 1 W/g * 5 min |
| Magnetic | Magnetic toner | Organic-inorganic | 2.8 | 2.7 | Silica fine | 2.6 | 2.184 | — | — | — | Apparatus shown | Pre-mixture |
| toner 5 | particle 1 | composite particle 1 | | | particle 1 | | | | | | in FIG. 4 | 1 W/g * 5 min |
| Magnetic | Magnetic toner | Organic-inorganic | 2.0 | 1.9 | Silica fine | 2 | 1.68 | — | — | — | Apparatus shown | Pre-mixture |
| toner 6 | particle 1 | composite particle 1 | | | particle 2 | | | | | | in FIG. 4 | 1 W/g * 5 min |
| Magnetic | Magnetic toner | Organic-inorganic | 2.0 | 1.9 | Silica fine | 2 | 1.68 | — | — | — | Apparatus shown | Pre-mixture |
| toner 7 | particle 1 | composite particle 1 | | | particle 3 | | | | | | in FIG. 4 | 1 W/g * 5 min |
| Magnetic | Magnetic toner | Organic-inorganic | 2.0 | 1.9 | Silica fine | 1.5 | 1.26 | — | — | — | Apparatus shown | Pre-mixture |
| toner 8 | particle 1 | composite particle 1 | | | particle 1 | | | | | | in FIG. 4 | 1 W/g * 5 min |
| Magnetic | Magnetic toner | Organic-inorganic | 2.0 | 1.9 | Silica fine | 1.3 | 1.092 | Alumina fine | 0.2 | 0.2 | Apparatus shown | Pre-mixture |
| toner 9 | particle 1 | composite particle 1 | | | particle 1 | | | particle | | | in FIG. 4 | 1 W/g * 5 min |
| Magnetic | Magnetic toner | Organic-inorganic | 2.0 | 1.9 | Silica fine | 1.3 | 1.092 | alumina fine | 0.1 + 0.1 | 0.1 + 0.1 | Apparatus shown | Pre-mixture |
| toner 10 | particle 1 | composite particle 1 | | | particle 1 | | | particle + | | | in FIG. 4 | 1 W/g * 5 min |
| | | | | | | | | titania fine | | | | |
| | | | | | | | | particle | | | | |
| Magnetic | Magnetic toner | Organic-inorganic | 2.0 | 1.9 | Silica fine | 2.5 | 2.1 | — | — | — | Apparatus shown | Pre-mixture |
| toner 11 | particle 1 | composite particle 1 | | | particle 1 | | | | | | in FIG. 4 | 1 W/g * 5 min |
| Magnetic | Magnetic toner | Organic-inorganic | 2.0 | 1.9 | Silica fine | 22 | 1.848 | Alumina fine | 0.3 | 0.3 | Apparatus shown | Pre-mixture |
| toner 12 | particle 1 | composite particle 1 | | | particle 1 | | | particle | | | in FIG. 4 | 1 W/g * 5 min |
| Magnetic | Magnetic toner | Organic-inorganic | 2.0 | 1.9 | Silica fine | 1.5 | 1.26 | — | — | — | Apparatus shown | Pre-mixture |
| toner 13 | particle 1 | composite particle 2 | | | particle 1 | | | | | | in FIG. 4 | 1.5 W/g * 5 min |
| Magnetic | Magnetic toner | Organic-inorganic | 2.0 | 1.9 | Silica fine | 1.5 | 1.26 | — | — | — | Apparatus shown | Pre-mixture |
| toner 14 | particle 1 | composite particle 3 | | | particle 1 | | | | | | in FIG. 4 | 0.5 W/g * 5 min |
| Magnetic | Magnetic toner | Organic-inorganic | 2.0 | 1.9 | Silica fine | 2.5 | 2.1 | — | — | — | Apparatus shown | Pre-mixture |
| toner 15 | particle 1 | composite particle 2 | | | particle 1 | | | | | | in FIG. 4 | 1.5 W/g * 5 min |
| Magnetic | Magnetic toner | Organic-inorganic | 2.0 | 1.9 | Silica fine | 2.5 | 2.1 | — | — | — | Apparatus shown | Pre-mixture |
| toner 16 | particle 1 | composite particle 3 | | | particle 1 | | | | | | in FIG. 4 | 0.5 W/g * 5 min |
| Magnetic | Magnetic toner | Organic-inorganic | 2.0 | 1.9 | Silica fine | 2.5 | 2.1 | — | — | — | Apparatus shown | Pre-mixture |
| toner 17 | particle 1 | composite particle 4 | | | particle 1 | | | | | | in FIG. 4 | 1.5 W/g * 5 min |
| Magnetic | Magnetic toner | Organic-inorganic | 2.0 | 1.9 | Silica fine | 2.5 | 2.1 | — | — | — | Apparatus shown | Pre-mixture |
| toner 18 | particle 1 | composite particle 5 | | | particle 1 | | | | | | in FIG. 4 | 1.5 W/g * 5 min |
| Magnetic | Magnetic toner | Organic-inorganic | 2.0 | 1.9 | Silica fine | 2.5 | 2.1 | — | — | — | Apparatus shown | Pre-mixture |
| toner 19 | particle 1 | composite particle 5 | | | particle 1 | | | | | | in FIG. 4 | 1.5 W/g * 5 min |
| Magnetic | Magnetic toner | Organic-inorganic | 2.0 | 1.9 | Silica fine | 2.5 | 2.1 | — | — | — | Apparatus shown | Pre-mixture |
| toner 20 | particle 2 | composite particle 5 | | | particle 1 | | | | | | in FIG. 4 | 1.5 W/g * 5 min |
| Magnetic | Magnetic toner | Organic-inorganic | 0.2 | 0.2 | Silica fine | 2 | 1.68 | — | — | — | Apparatus shown | Pre-mixture |
| toner 21 | particle 1 | composite particle 1 | | | particle 1 | | | | | | in FIG. 4 | 1 W/g * 5 min |
| Magnetic | Magnetic toner | Organic-inorganic | 3.5 | 3.4 | Silica fine | 2 | 1.68 | — | — | — | Apparatus shown | Pre-mixture |
| toner 22 | particle 1 | composite particle 1 | | | particle 1 | | | | | | in FIG. 4 | 1 W/g * 5 min |
| Magnetic | Magnetic toner | Organic-inorganic | 2.0 | 1.9 | Silica fine | 1.2 | 1.008 | Alumina fine | 0.3 | 0.3 | Apparatus shown | Pre-mixture |
| toner 23 | particle 1 | composite particle 1 | | | particle 1 | | | particle | | | in FIG. 4 | 1 W/g * 5 min |
| Magnetic | Magnetic toner | Organic-inorganic | 2 | 1.92 | Silica fine | 2 | 1.68 | — | — | — | Apparatus shown | Pre-mixture |
| toner 24 | particle 1 | composite particle 1 | | | particle 4 | | | | | | in FIG. 4 | 1 W/g * 5 min |
| Magnetic | Magnetic toner | Organic-inorganic | 2 | 1.92 | Silica fine | 2 | 1.68 | — | — | — | Henschel mixer | 4000 rpm × 3 min |
| toner 25 | particle 1 | composite particle 1 | | | particle 1 | | | | | | | |
| Magnetic | Magnetic toner | Colloidal silica | 2 | — | Silica fine | 2 | — | — | — | — | Apparatus shown | Pre-mixture |
| toner 26 | particle 1 | | | | particle 1 | | | | | | in FIG. 4 | 1 W/g * 5 min |
| Magnetic | Magnetic toner | Epostar particle | 2 | 1.92 | Silica fine | 2 | 1.68 | — | — | — | Apparatus shown | Pre-mixture |
| toner 27 | particle 1 | (resin particle) | | | particle 1 | | | | | | in FIG. 4 | 1 W/g * 5 min |

### Example 1

Magnetic toner 1 was evaluated as follows.

### Evaluation of Toner Sweeping for Example

Evaluation was performed by HP LaserJet Enterprise600 M603dn. The main body was modified such that images having different (development) contrast can be output by connecting an external electric source. A predetermined process cartridge was charged with magnetic toner 1 (1000 g) and images were output in normal conditions (23° C., 50% RH). A durability test was performed using two lateral patterns having a printing ratio of 1%/one job in such mode that the machine was once stopped between jobs and then a next job was started. In this manner, 50,000 sheets in total were printed out in this test.

Images were evaluated by changing a setting value from 150V to 500V to change a development contrast so as to obtain a solid image density of 1.3. As an image to be evaluated, an image having a lateral line solid image followed by a solid white image was output and subjected to sweeping evaluation. Evaluation was made in the initial image and 50000th image.

The image density was determined by measuring the reflecting density of a solid black image by using a reflecting densitometer, i.e., Macbeth densitometer (manufactured by Macbeth) and using an SPI filter. Sweeping was evaluated by measuring the width of a high-density portion in a rear part of a solid image.

A: less than 0.2 mm
B: 0.2 or more and less than 0.7 mm
C: 0.7 or more and less than 1.2 mm
D: 1.2 mm or more

[Evaluation of Low-Temperature Fixability]

The fixing apparatus, HP LaserJet Enterprise 600 M603dn, was modified so as to arbitrarily set the fixation temperature.

A fixing unit was controlled such that the temperature was changed by every 5° C. within the range of 200° C. or more and 245° C. or less. Using the modified apparatus, a half tone image was output on a bond paper (basis weight: 75 g/m²) such that the half tone image had an image density of 0.6 to 0.65. The obtained image was reciprocally rubbed five times by lens-cleaning paper while applying a load of 4.9 kPa to the paper. A reduction rate of image density before and after the rubbing was determined. Based on the relationship between the fixation temperature and the density reduction rate, the temperature giving a density reduction rate of 10% was obtained and used for evaluation of low-temperature fixability. The lower the temperature, the more excellent the low-temperature fixability. Evaluation was made under the normal environment (23° C., 50% RH).

Magnetic toner 1 was subjected to the above evaluation. The physical properties and evaluation results of magnetic toners are shown in Table 3.

### Examples 2 to 5

Magnetic toners 2 to 5 were obtained in the same manner as in Example 1 except that the addition amounts of the organic-inorganic composite particle and first inorganic fine particle were changed, and evaluated in the same manner. Production Examples of the toners are shown in Table 2. As a result, it was found that practically acceptable images satisfying all evaluation items can be obtained. The physical properties and evaluation results of the magnetic toners are shown in Table 3.

### Examples 6 to 12

Magnetic toners 6 to 12 were obtained in the same manner as in Example 1 except that the type and addition amount of the first inorganic fine particle were changed, and evaluated in the same manner. Production Examples of the toners are shown in Table 2. As a result, it was found that practically acceptable images satisfying all evaluation items can be obtained. The physical properties and evaluation results of the magnetic toners are shown in Table 3.

### Examples 13 to 19

Magnetic toners 13 to 19 were obtained in the same manner as in Example 1 except that the type of large particle-diameter external additive, the addition amount of first inorganic fine particle and external addition conditions were changed, and evaluated in the same manner. Production Example of the toners are shown in Table 2. As a result, it was found that practically acceptable images satisfying all evaluation items can be obtained. The physical properties and evaluation results of the magnetic toners are shown in Table 3.

### Example 20

Magnetic toner 20 was obtained in the same manner as in Example 18 except that the magnetic particle was changed, and evaluated in the same manner. Production Example of the toner is shown in Table 2. As a result, it was found that practically acceptable images satisfying all evaluation items could be obtained. The physical properties and evaluation results of the magnetic toner are shown in Table 3.

### Comparative Examples 1 and 2

Magnetic toners 21 and 22 were obtained in the same manner as in Example 1 except that the addition amount of the organic-inorganic composite particle was changed, and evaluated in the same manner. As a result, it was found that if the addition amount of the organic-inorganic composite particle was low, sweeping was unfavorable, and that if the addition amount of the organic-inorganic composite particle was high, fixability was unfavorable. The physical properties and evaluation results of the magnetic toners are shown in Table 3.

### Comparative Examples 3 and 4

Magnetic toners 23 and 24 were obtained in the same manner as in Example 1 except that the type and addition amount of the first inorganic fine particle were changed, and evaluated in the same manner. As a result, it was found that if the ratio of a silica fine particle was low, sweeping was significantly unfavorable in practical point of view, and that if the particle diameter of the first inorganic fine particle was large, sweeping was unfavorable. The physical properties and evaluation results of the magnetic toners are shown in Table 3.

### Comparative Example 5

Magnetic toner 25 was obtained in the same manner as in Example 1 except that Henschel mixer (manufactured by NIPPON COKE & ENGINEERING, CO., LTD.) was used in place of the external addition apparatus used in Example 1 and external addition was performed in the conditions of 4000 rpm for 3 minutes, and evaluated in the same manner. As a result, it was found that sweeping was unfavorable. The physical properties and evaluation results of the magnetic toner are shown in Table 3.

### Comparative Examples 6 and 7

Magnetic toners 26 and 27 were obtained in the same manner as in Example 1 except that the organic-inorganic composite particle was changed to a colloidal silica and a resin particle, respectively, and evaluated in the same manner. As a result, it was found that sweeping was unfavorable. The physical properties and evaluation results of the magnetic toners are shown in Table 3.

TABLE 3
Physical properties of toner and evaluation results

| | | Large particle-diameter | First inorganic fine particle | | | | Physical properties of toner | | | | | | |
|---|---|---|---|---|---|---|---|---|---|---|---|---|---|
| | | external additive | | Number average | | Number average | | | | | Ratio of silica | | |
| | | Number average particle | | particle diameter | | particle diameter | | | | | fine particle in | Evaluation results | |
| | | diameter obtained by | | obtained by surface | | obtained by surface | | Variation | | | inorganic | | Low |
| | | surface observation of | | observation of toner | | observation of toner | Coverage | coefficient of | Coverage | | oxide fine | | temperature |
| | | toner [nm] | Type | [nm] | Type | [nm] | ratio A | coverage ratio A | ratio B | B/A | particle (%) | Sweeping | fixability |
| Example 1 | Magnetic | 113 | Silica fine | 12 | — | — | 58.2 | 6.7 | 42.9 | 0.74 | 100 | A | 220 |
| | toner 1 | | particle 1 | | | | | | | | | | |
| Example 2 | Magnetic | 112 | Silica fine | 11 | — | — | 56.4 | 6.4 | 41.8 | 0.74 | 100 | A | 219 |
| | toner 2 | | particle 1 | | | | | | | | | | |
| Example 3 | Magnetic | 113 | Silica fine | 12 | — | — | 55.3 | 6.6 | 41.2 | 0.75 | 100 | B | 217 |
| | toner 3 | | particle 1 | | | | | | | | | | |
| Example 4 | Magnetic | 114 | Silica fine | 10 | — | — | 56.8 | 6.1 | 40.1 | 0.71 | 100 | A | 230 |
| | toner 4 | | particle 1 | | | | | | | | | | |
| Example 5 | Magnetic | 110 | Silica fine | 11 | — | — | 57.9 | 5.9 | 42.3 | 0.73 | 100 | A | 235 |
| | toner 5 | | particle 1 | | | | | | | | | | |
| Example 6 | Magnetic | 111 | Silica fine | 8 | — | — | 58.1 | 6.2 | 42.8 | 0.74 | 100 | A | 222 |
| | toner 6 | | particle 2 | | | | | | | | | | |
| Example 7 | Magnetic | 112 | Silica fine | 26 | — | — | 58.2 | 8.0 | 43.1 | 0.74 | 100 | B | 223 |
| | toner 7 | | particle 3 | | | | | | | | | | |
| Example 8 | Magnetic | 113 | Silica fine | 11 | — | — | 47.1 | 7.0 | 33.2 | 0.70 | 100 | A | 221 |
| | toner 8 | | particle 1 | | | | | | | | | | |
| Example 9 | Magnetic | 114 | Silica fine | 11 | Alumina fine | 15 | 46.8 | 6.9 | 33.4 | 0.71 | 85 | B | 220 |
| | toner 9 | | particle 1 | | particle | | | | | | | | |
| Example 10 | Magnetic | 113 | Silica fine | 13 | alumina fine | 16/16 | 45.1 | 6.5 | 31.2 | 0.69 | 85 | C | 220 |
| | toner 10 | | particle 1 | | particle + | | | | | | | | |
| | | | | | titania fine | | | | | | | | |
| | | | | | particle | | | | | | | | |
| Example 11 | Magnetic | 112 | Silica fine | 12 | — | — | 68.4 | 5.7 | 50.0 | 0.73 | 100 | A | 231 |
| | toner 11 | | particle 1 | | | | | | | | | | |
| Example 12 | Magnetic | 113 | Silica fine | 11 | Alumina fine | 14 | 67.0 | 5.8 | 51.0 | 0.76 | 86 | B | 232 |
| | toner 12 | | particle 1 | | particle | | | | | | | | |
| Example 13 | Magnetic | 143 | Silica fine | 13 | — | — | 46.8 | 6.9 | 39.1 | 0.84 | 100 | B | 220 |
| | toner 13 | | particle 1 | | | | | | | | | | |
| Example 14 | Magnetic | 62 | Silica fine | 12 | — | — | 46.9 | 7.2 | 25.1 | 0.54 | 100 | A | 230 |
| | toner 14 | | particle 1 | | | | | | | | | | |
| Example 15 | Magnetic | 144 | Silica fine | 12 | — | — | 67.6 | 6.0 | 56.3 | 0.83 | 100 | B | 229 |
| | toner 15 | | particle 1 | | | | | | | | | | |
| Example 16 | Magnetic | 61 | Silica fine | 13 | — | — | 68.2 | 6.2 | 35.6 | 0.52 | 100 | B | 233 |
| | toner 16 | | particle 1 | | | | | | | | | | |
| Example 17 | Magnetic | 106 | Silica fine | 11 | — | — | 67.5 | 5.9 | 56.0 | 0.83 | 100 | B | 227 |
| | toner 17 | | particle 1 | | | | | | | | | | |
| Example 18 | Magnetic | 99 | Silica fine | 13 | — | — | 67.8 | 5.8 | 56.2 | 0.83 | 100 | C | 234 |
| | toner 18 | | particle 1 | | | | | | | | | | |
| Example 19 | Magnetic | 100 | Silica fine | 15 | — | — | 67.8 | 9.9 | 56.2 | 0.83 | 100 | C | 230 |
| | toner 19 | | particle 1 | | | | | | | | | | |
| Example 20 | Magnetic | 98 | Silica fine | 11 | — | — | 67.8 | 6.1 | 56.2 | 0.83 | 100 | B | 220 |
| | toner 20 | | particle 1 | | | | | | | | | | |
| Comparative | Magnetic | 112 | Silica fine | 12 | — | — | 58.4 | 6.4 | 43.3 | 0.74 | 100 | D | 222 |
| Example 1 | toner 21 | | particle 1 | | | | | | | | | | |
| Comparative | Magnetic | 113 | Silica fine | 13 | — | — | 58.3 | 6.5 | 43.2 | 0.74 | 100 | A | 240 |
| Example 2 | toner 22 | | particle 1 | | | | | | | | | | |
| Comparative | Magnetic | 114 | Silica fine | 11 | Alumina fine | 15 | 46.8 | 7.2 | 33.1 | 0.71 | 75 | D | 221 |
| Example 3 | toner 23 | | particle 1 | | particle | | | | | | | | |
| Comparative | Magnetic | 113 | Silica fine | 43 | — | — | 40.8 | 10.3 | 19.3 | 0.47 | 100 | D | 232 |
| Example 4 | toner 24 | | particle 4 | | | | | | | | | | |
| Comparative | Magnetic | 111 | Silica fine | 16 | — | — | 44.0 | 13.1 | 18.1 | 0.41 | 100 | D | 230 |
| Example 5 | toner 25 | | particle 1 | | | | | | | | | | |
| Comparative | Magnetic | 120 | Silica fine | 13 | — | — | 57.8 | 6.5 | 43.5 | 0.75 | — | D | 238 |
| Example 6 | toner 26 | | particle 1 | | | | | | | | | | |
| Comparative | Magnetic | 115 | Silica fine | 12 | — | — | 57.4 | 6.2 | 43.1 | 0.7509 | 100 | D | 240 |
| Example 7 | toner 27 | | particle 1 | | | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-158913, filed Jul. 31, 2013, which is hereby incorporated by reference herein in its entirety.

### REFERENCE SIGNS LIST

1: main-body casing, 2: rotating body, 3, 3a, 3b: stirring member, 4: jacket, 5: raw material feed port, 6: Product ejection port, 7: center axis, 8: driving portion, 9: treatment space, 10: rotating body end parts) side surface, 11: rotation direction, 12: backward direction, 13: feed direction, 16: inner piece for a raw material feed port, 17: inner piece for product ejection port, d: width of overlapped portion of stirring members, D: width of a stirring member, 100: photosensitive drum, 102: toner carrier, 103: development blade, 114: transfer member (transfer charging roller), 116: cleaner container, 117: charging member (charging roller), 121: laser generator (latent image forming unit, light exposure apparatus), 123: laser, 124: pick-up roller, 125: handler belt, 126: fixing unit, 140: developer, 141: stirring member

What is claimed is:

1. A magnetic toner comprising
a toner particle comprising a binder resin and a magnetic member,
a first inorganic fine particle, and
an organic-inorganic composite particle,
the first inorganic fine particle and the organic-inorganic composite particle being on the surface of the toner particle,
wherein
the organic-inorganic composite particle
i) has a structure in which a second inorganic fine particle is embedded in a resin particle, and
ii) is contained in an amount of 0.5 mass % or more and 3.0 mass % or less based on the mass of the magnetic toner;
the first inorganic fine particle
i) contains an inorganic oxide fine particle selected from the group consisting of a silica fine particle, a titanium oxide fine particle and an alumina fine particle, with the proviso that the silica fine particle is contained in an amount of 85 mass % or more based on the inorganic oxide fine particle, and
ii) has a number average particle diameter (D1) of 5 nm or more and 25 nm or less; and
when the coverage ratio of the toner-particle surface with the first inorganic fine particle is represented by “coverage ratio A (%)” and the coverage ratio of the toner-particle surface with the first inorganic fine particle fixed onto the toner-particle surface is represented by “coverage ratio B (%)”, the coverage ratio A is 45.0% or more and 70.0% or less and the ratio (B/A) of the coverage ratio B to the coverage ratio A is 0.50 or more and 0.85 or less.

2. The magnetic toner according to claim 1, wherein a variation coefficient of the coverage ratio A is 10.0% or less.

3. The magnetic toner according to claim 1, wherein the organic-inorganic composite particle has a volumetric specific heat at 80° C. is 2900 kJ/(m³·° C.) or more and 4200 kJ/(m³·° C.) or less.

4. The magnetic toner according to claim 1, wherein the organic-inorganic composite fine particle has a plurality of convexes due to the second inorganic fine particle in a surface thereof and has a number-average particle diameter of 50 nm or more and 200 nm or less.
